(19) United States
(12) Patent Application Publication
(10) Pub. No.: US 2024/0091975 A1
(43) Pub. Date: Mar. 21, 2024

(54) SAWMILL WITH A ROCKING CARRIAGE

(71) Applicant: Jeff Barber, West Plains, MO (US)

(72) Inventor: Jeff Barber, West Plains, MO (US)

(21) Appl. No.: 18/151,656

(22) Filed: Jan. 9, 2023

Related U.S. Application Data
(63) Continuation-in-part of application No. 17/102,550, filed on Nov. 24, 2020, now abandoned.
Application No. 17/102,550 is a division of application No. 15/656,044, filed on Jul. 21, 2017, now Pat. No. 10,857,693.
(60) Provisional application No. 62/365,067, filed on Jul. 21, 2016.
(60) Provisional application No. 62/375,614, filed on Aug. 16, 2016.

(51) Int. Cl. B27B 13/04; B27B 31/00; B27B 33/06; B27L 1/12

(52) U.S. Cl. CPC B27B 13/04; B27B 31/006; B27B 33/06; B27L 1/127

(57) ABSTRACT

A sawmill for tree logs includes a rocking carriage to pick up fresh logs and feed them into the path of a saw blade, as well further provisions relating to improvements to infeed systems for the fresh logs, as well as to, outflow systems for transfer of sawn-off product to a production line conveyor or the like for further processing to downline processes after the first saw cuts on the fresh logs.

### CROSS-REFERENCE TO RELATED APPLICATION(S)

This application is a continuation-in-part of U.S. patent application Ser. No. 17/102,550, filed Nov. 24, 2020; which is a divisional of U.S. patent application Ser. No. 15/656,044, filed Jul. 21, 2017, now U.S. Pat. No. 10,857,693; which claims the benefit of U.S. Provisional Application No. 62/365,067, filed Jul. 21, 2016; and U.S. Provisional Application No. 62/375,614, filed Aug. 16, 2016. The foregoing patent disclosures are incorporated herein by this reference thereto.

### BACKGROUND AND SUMMARY OF THE INVENTION

The invention relates to sawmills and, more particularly, to aspects related to increased automation thereof including without limitation a rocking carriage.

The invention alternatively more particularly relates to, for an inclined band mill (eg., an inclined band saw on a traversing carriage), certain further provisions relating to improvements to infeed systems of fresh logs, as well as, outflow systems for sawn-off product to a conveyor for further processing down a production line conveyor. The logs typically weigh four thousand pounds (˜eighteen hundred kilograms), with many typically exceeding that weight.

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a left-side, side elevation view of a first embodiment of a sawmill (25) in accordance with the invention provided with a rocking carriage (30) in accordance with the invention as well as an outflow conveyor system (80) in accordance with the invention:—wherein, given the orientation of this view, the infeed of a fresh log (36) onto the series of frame members (38) that cooperatively form a tilting log bunk (42) arrives from the right-side in this view, which fresh log (36) will be pushed/conveyed to the opposite side of the log bunk (42), which is the left side in this view, and which is side where the saw operations are executed;

FIG. 1A is a reproduction of FIG. 13 in U.S. Pat. No. 4,341,248—Critchell et al., which is a side elevation view counterpart to FIG. 1 hereof, wherein the flow direction of a fresh log from the infeed side to the side where the saw operations are executed are correspondingly right to left also;

FIG. 1B is an enlarged-scale side elevation view of the left-half of FIG. 1A;

FIG. 1C is a reproduction of FIG. 12 in U.S. Pat. No. 4,341,248—Critchell et al., which is a side elevation view counterpart to FIG. 5 hereof;

FIG. 1D is an enlarged-scale side elevation view of the left-half of FIG. 1C;

FIG. 2 is a top plan view of FIG. 1 hereof, with the bandsaw (32) that traverses cyclically in strokes back and forth from left-to-right (given the orientation of this view) shown in the extreme right position (which comprises a relative “home” position);

FIGS. 3-8 (excluding FIGS. 3A-3E, 4A and 5A) are a series of left-side, side elevation views, partly in section, showing a series of movements by the rocking carriage (30) for loading a fresh new log (36) into a chucked-position as chucked by a plurality of spaced head assemblies (50), and also show the results of one or more passes of the bandsaw (32) to form sawed-off slices or planks (78), wherein:—FIG. 3 is a side elevation view, partly in section, taken in the direction of arrows III-III in FIG. 2, and showing the tilting log bunk (42) of the rocking carriage (30) tilted approximately parallel to an 11 o'clock to 5 o'clock axis on an imaginary clock face;

FIGS. 3A-3E are more particularly described below following the description of FIG. 8;

FIG. 4 is a side elevation view, partly in section, comparable to FIG. 3, except showing the series of frame members (38) that cooperatively form the tilting log bunk (42) shifted to a flatter angle, or approximately parallel to a 9:40 to 3:40 axis on the imaginary clock face;

FIG. 4A is more particularly described below following the descriptions of FIGS. 3A-3E that follow the description of FIG. 8;

FIG. 5 is a side elevation view, partly in section, comparable to FIG. 4, except showing the only head assembly (50) in view shifted from an extreme retracted position, as shown in dashed lines, to a relatively more forward position shown in solid lines;

FIG. 5A is more particularly described below following the descriptions of FIGS. 3A-3E and 4A that follow the description of FIG. 8;

FIG. 6 is a side elevation view, partly in section, comparable to FIG. 5, except showing that the log (36) has had a couple or more of sawn off slices or planks (78) sawn off by a couple or more passes by the bandsaw blade (70) and that the proximal head assembly (50) has shifted back down the slope of one of the five parallel pairs of frame members (38) (which five parallel pairs of frame members (38) that cooperatively form tilting log bunk (42)) to the position as shown (ie., in solid lines);

FIG. 7 is a side elevation view, partly in section, comparable to FIG. 6, except showing that the log (36) has been rolled a quarter of a turn counter-clockwise to land on its flat face (ie., the only flat face for the log (36) at this stage), as accomplished by the clockwise travel in an endless circuit by the dog (60) as indicated in FIG. 6 by the dashed-line, clockwise arcuate arrow (62), wherein here in this FIG. 7 the dashed-line arcuate arrow (62) has been reversed to the counter-clockwise direction to signify the dog (60) reversing travel in order to return biting into (or chucking) the top of the log (36); and

FIG. 8 is a side elevation view, partly in section, and comparable to all of FIGS. 3 through 7, and showing that the operations shown by FIGS. 5 through 7 are successively repeatable such that the log (36) may be been reduced to a quadrilateral beam, approximately as shown;

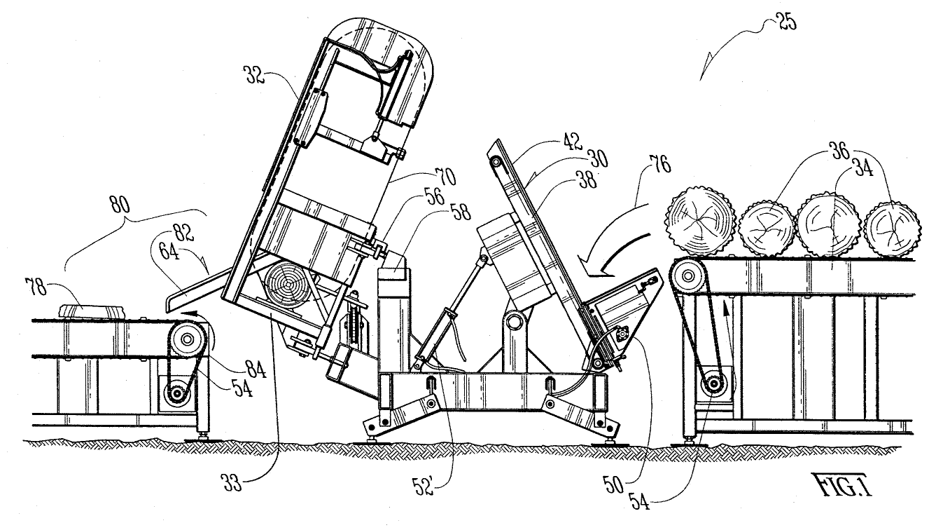

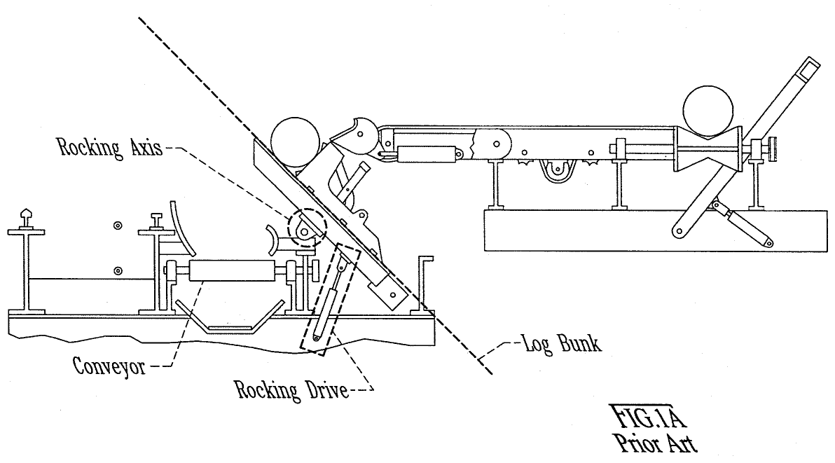

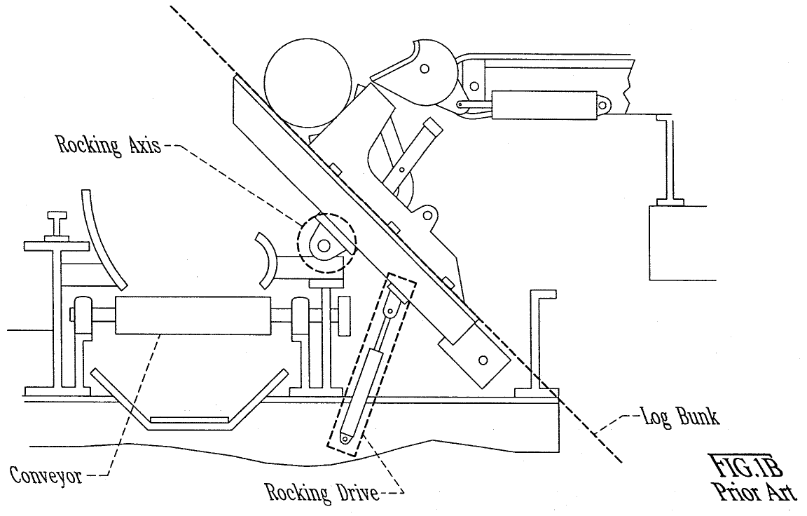

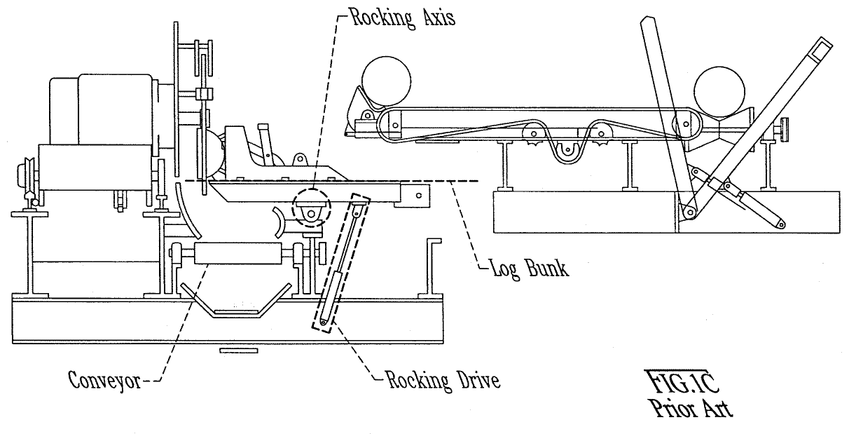

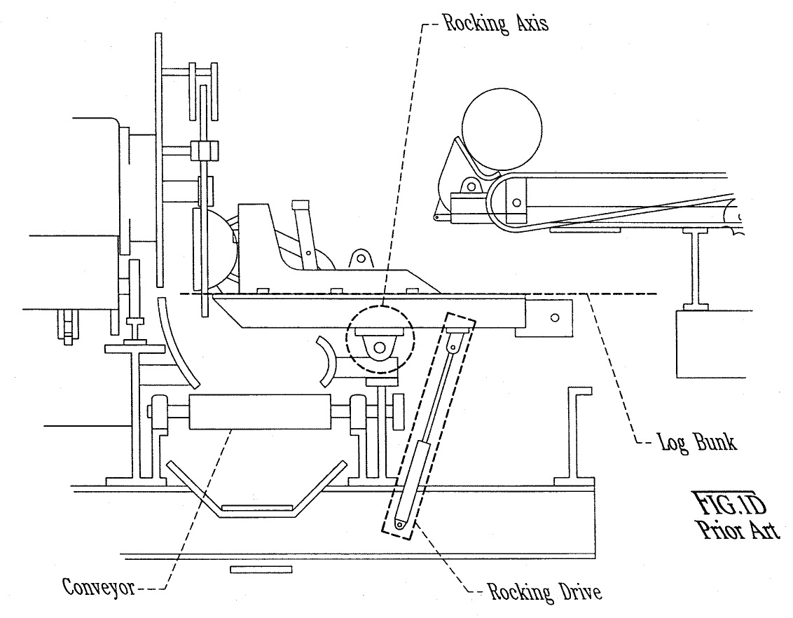

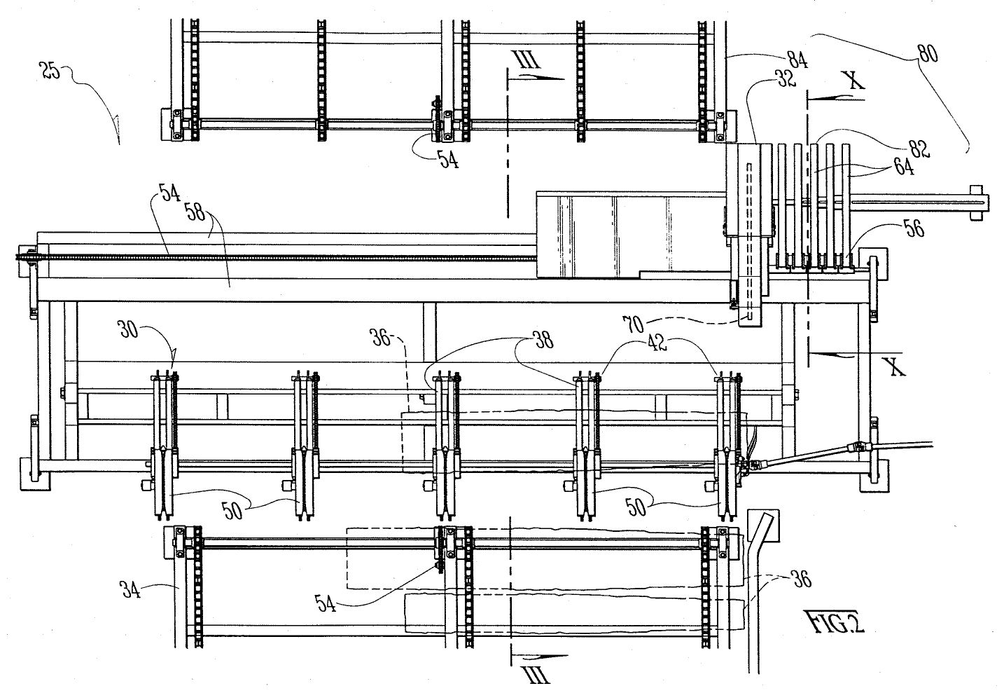

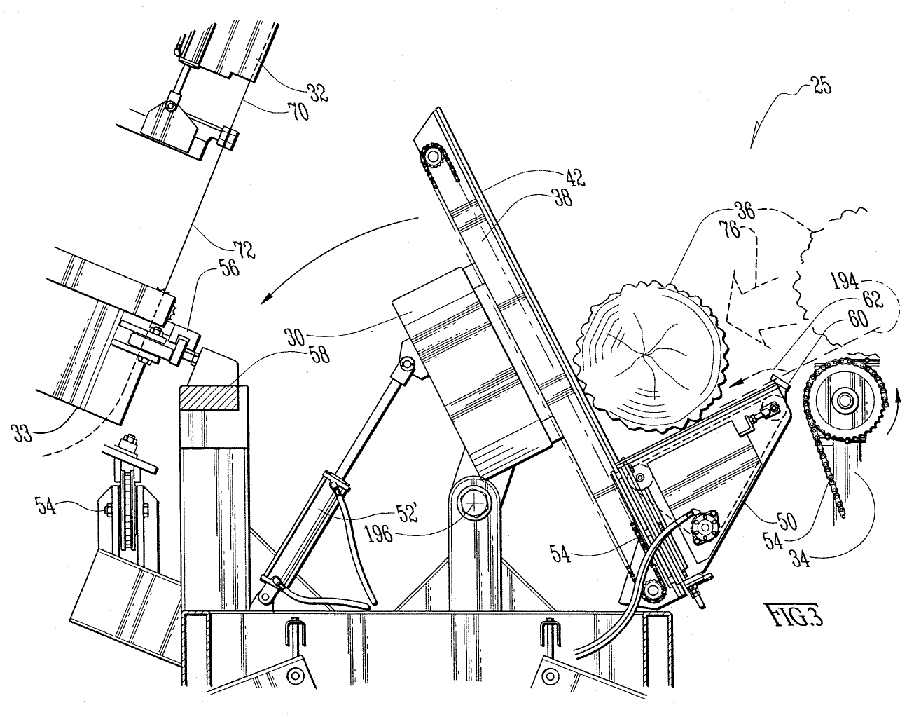

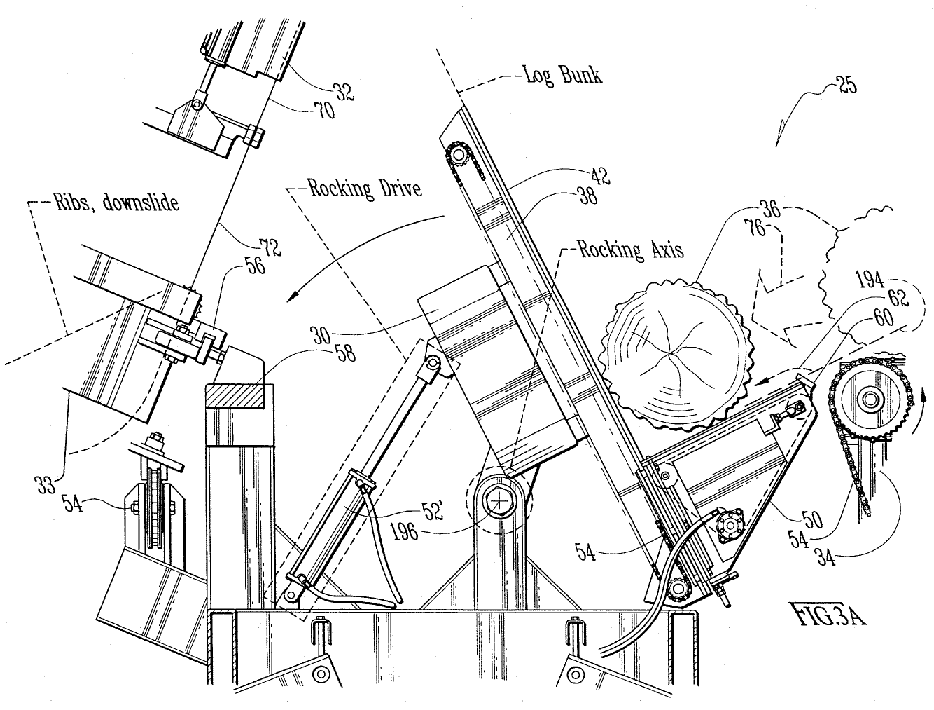

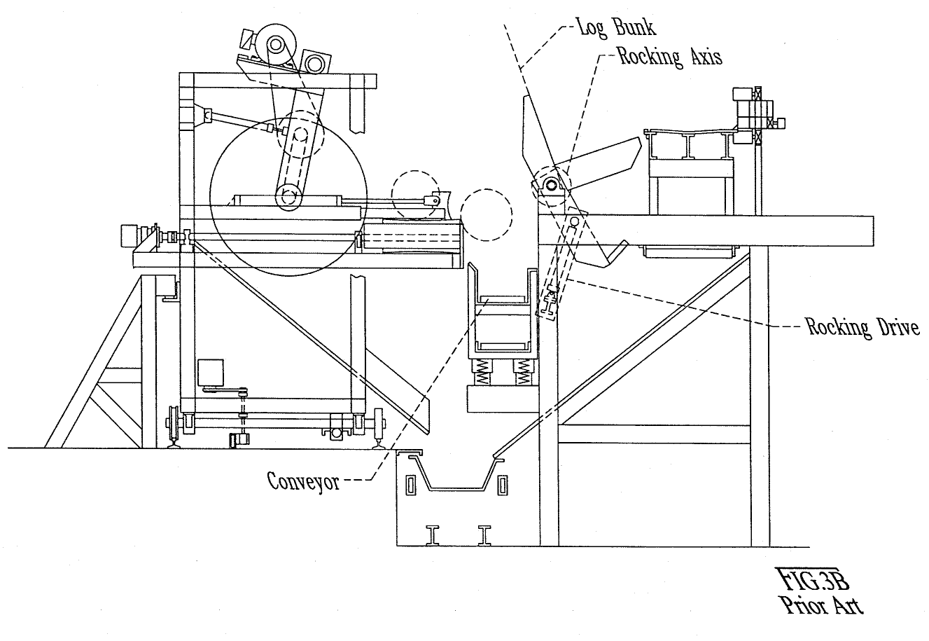

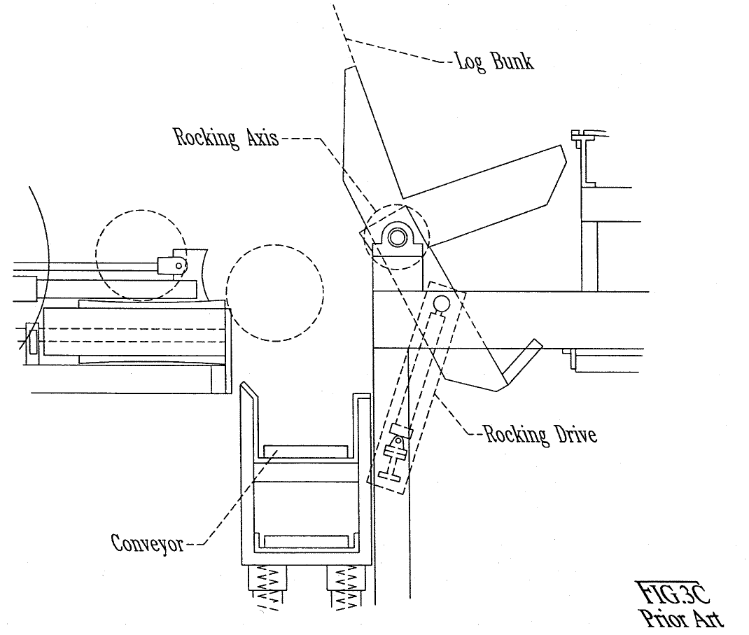

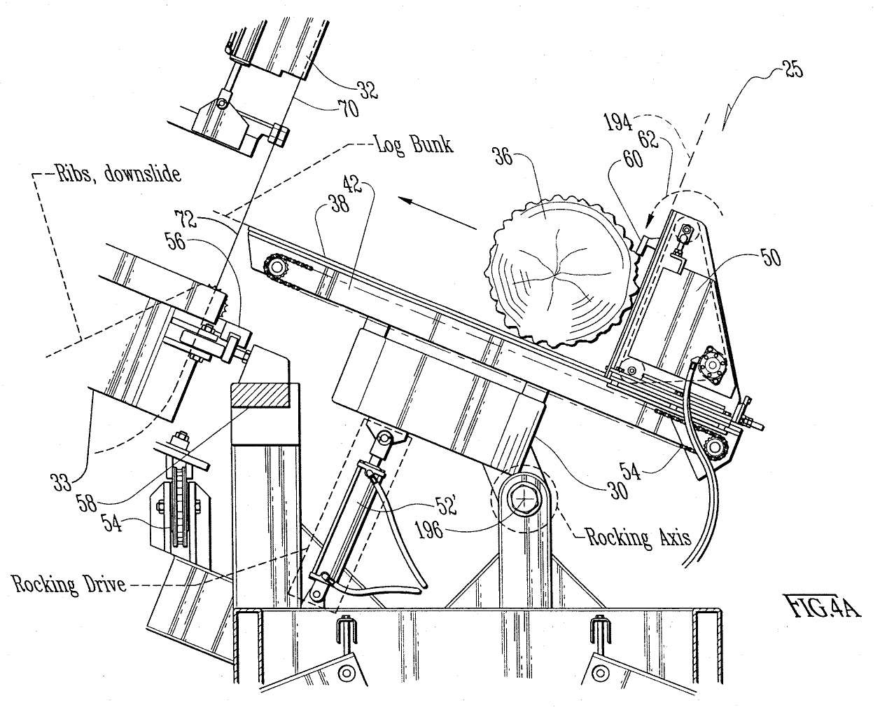

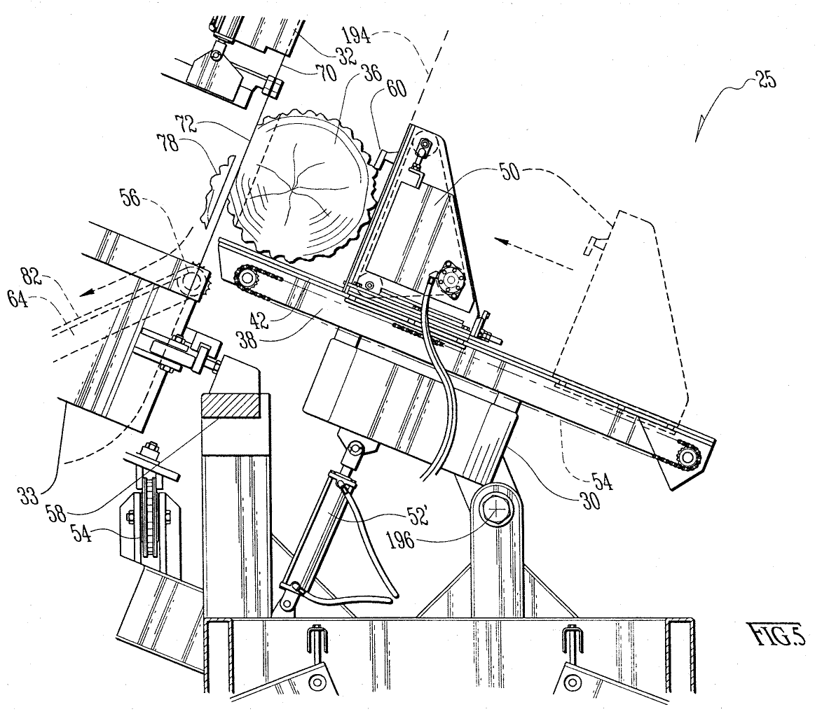

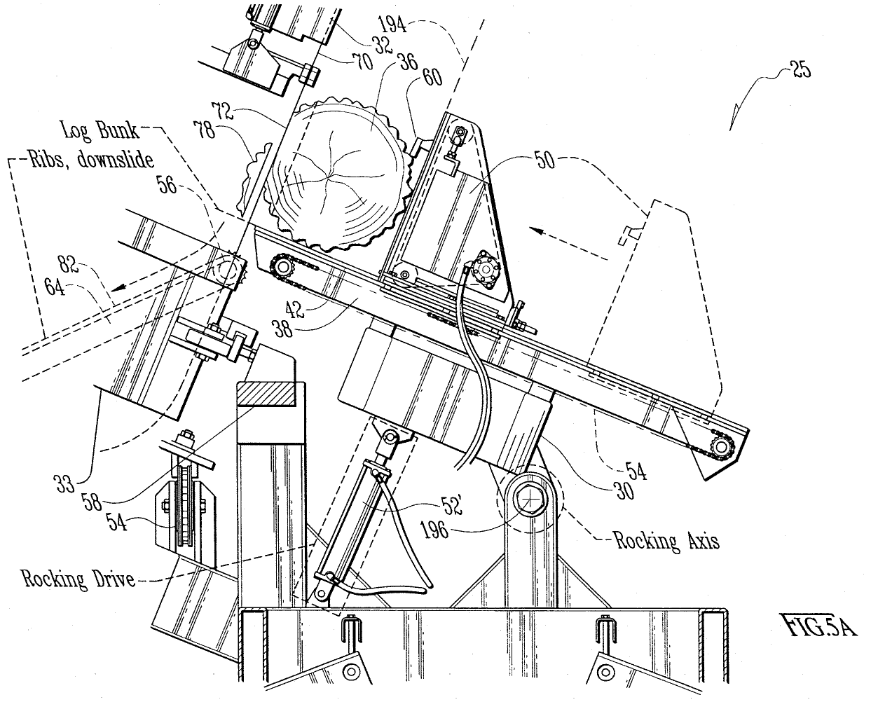

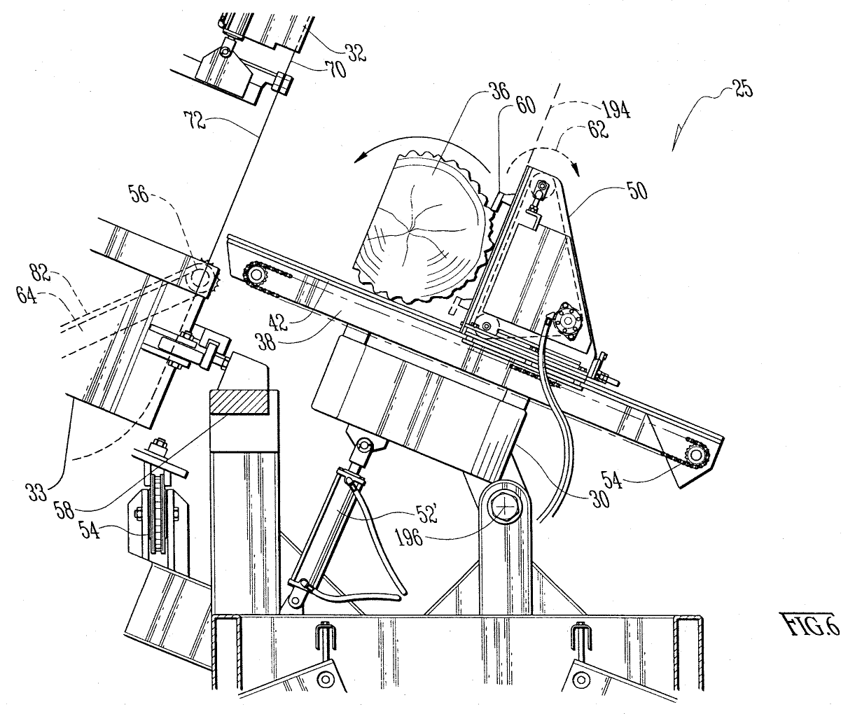

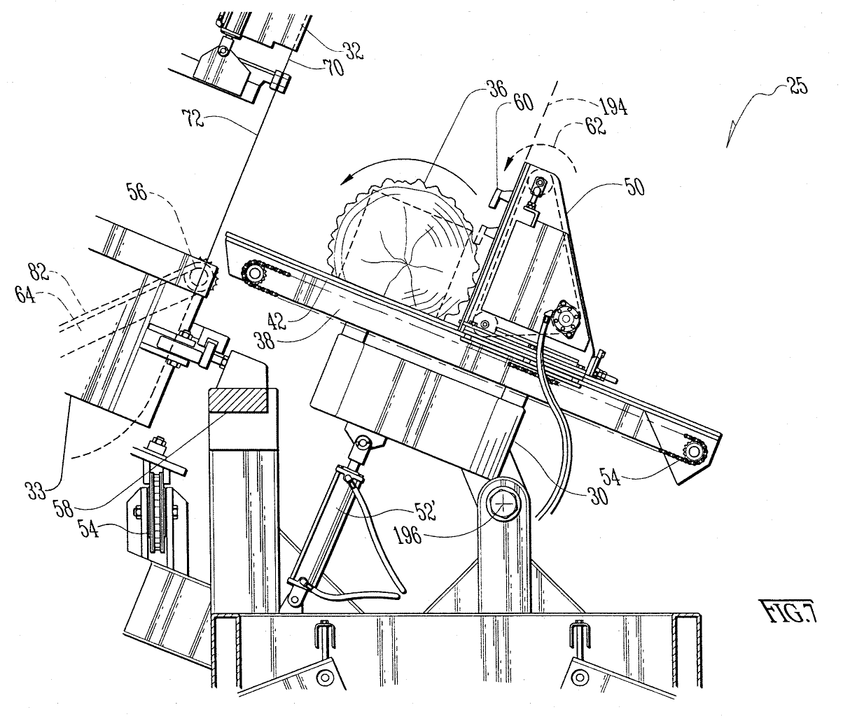

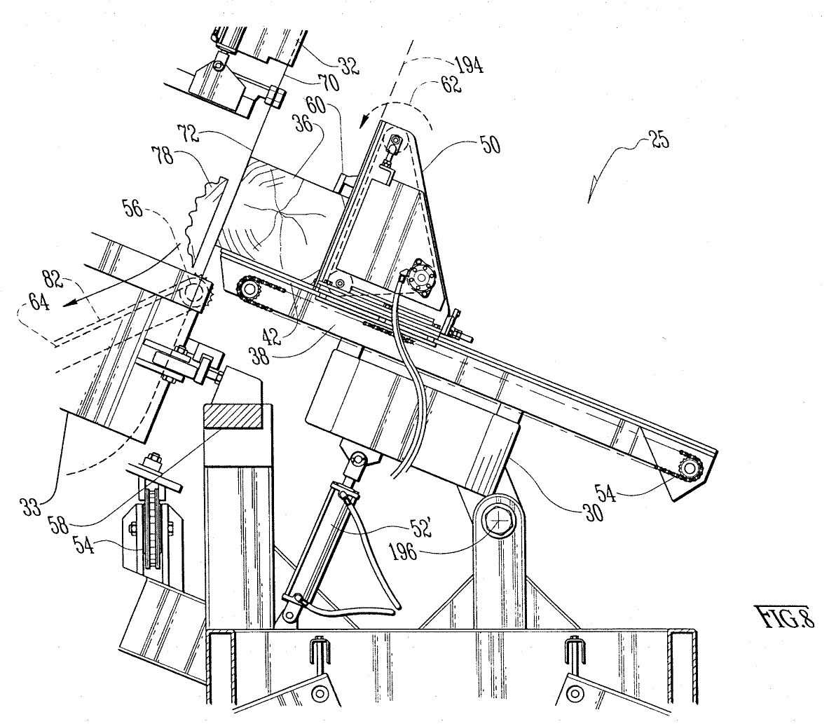

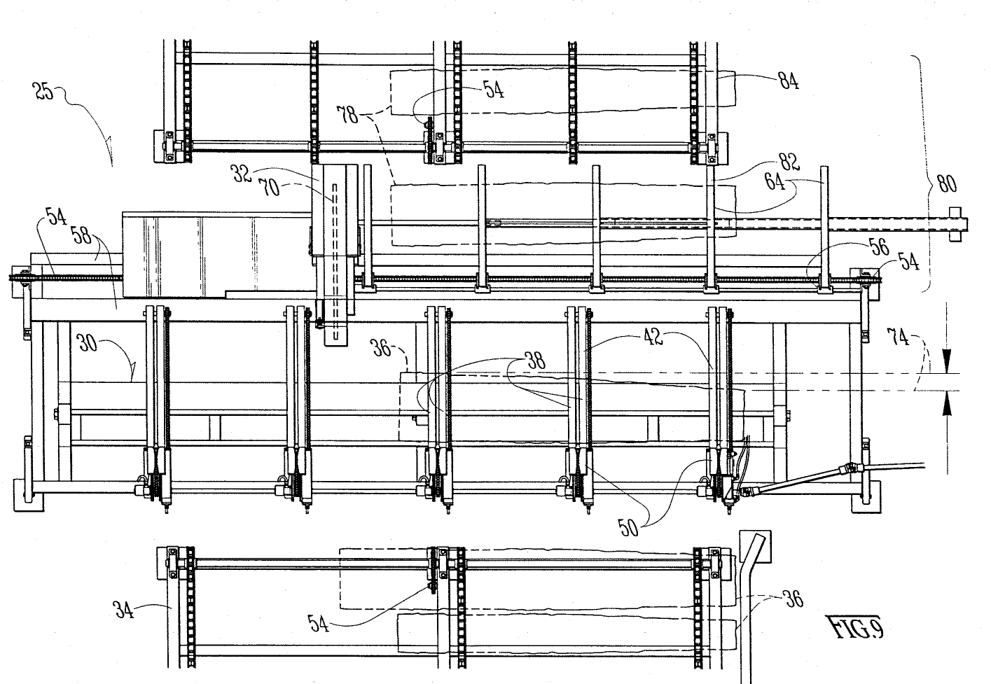

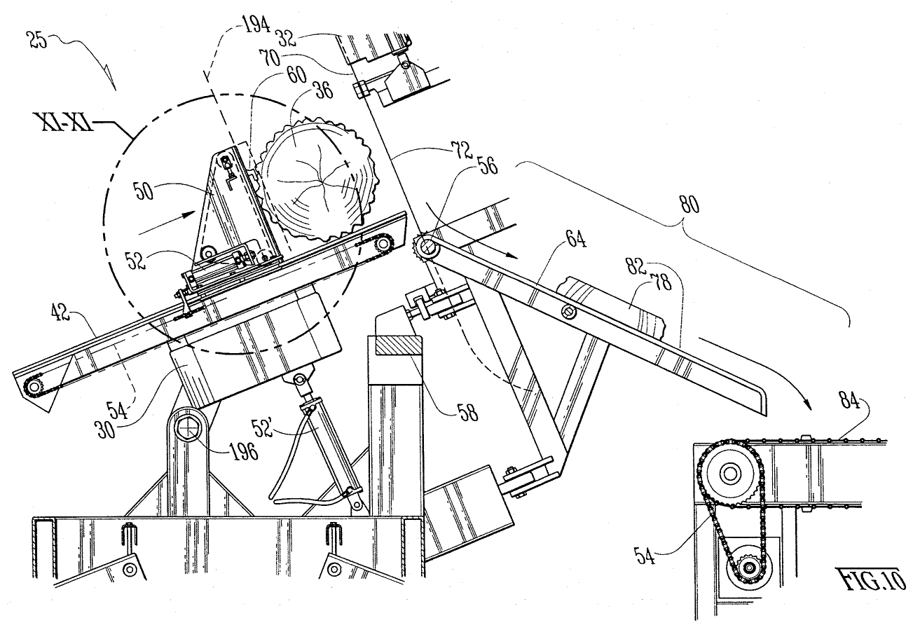

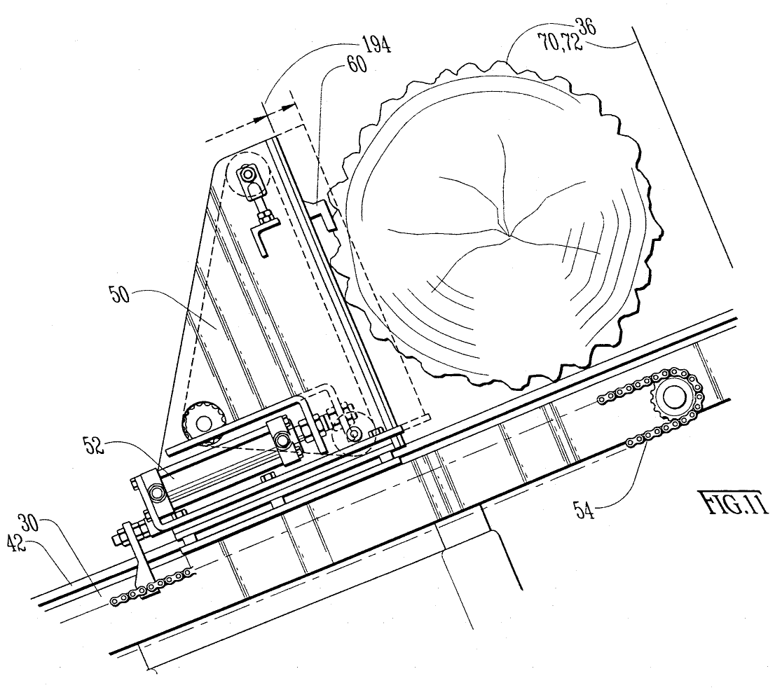

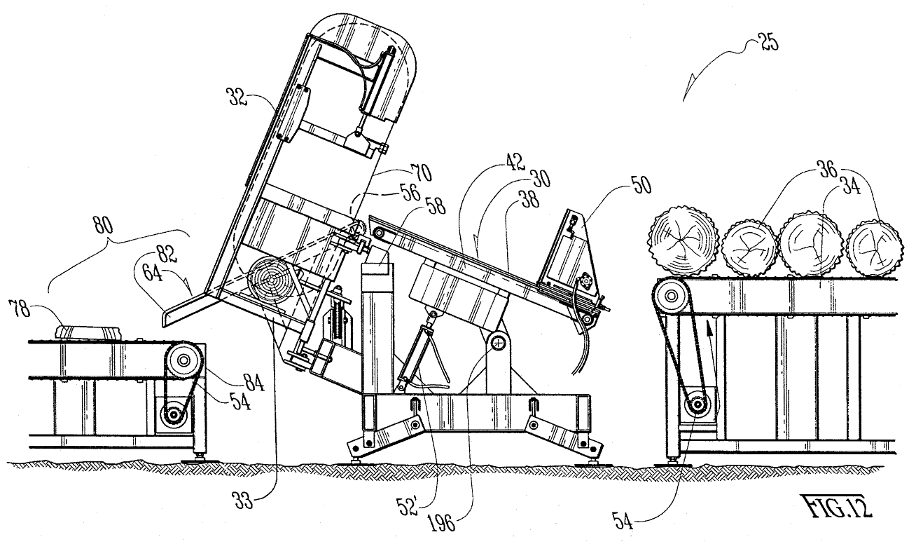

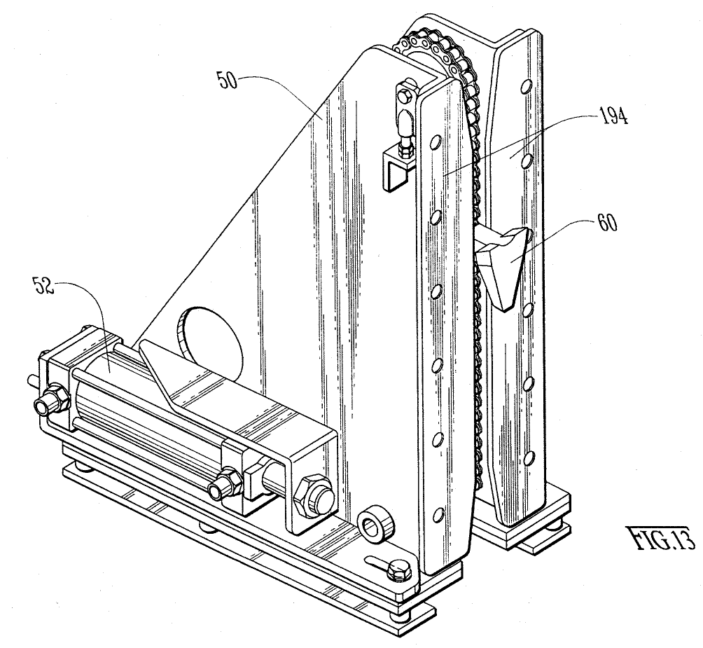

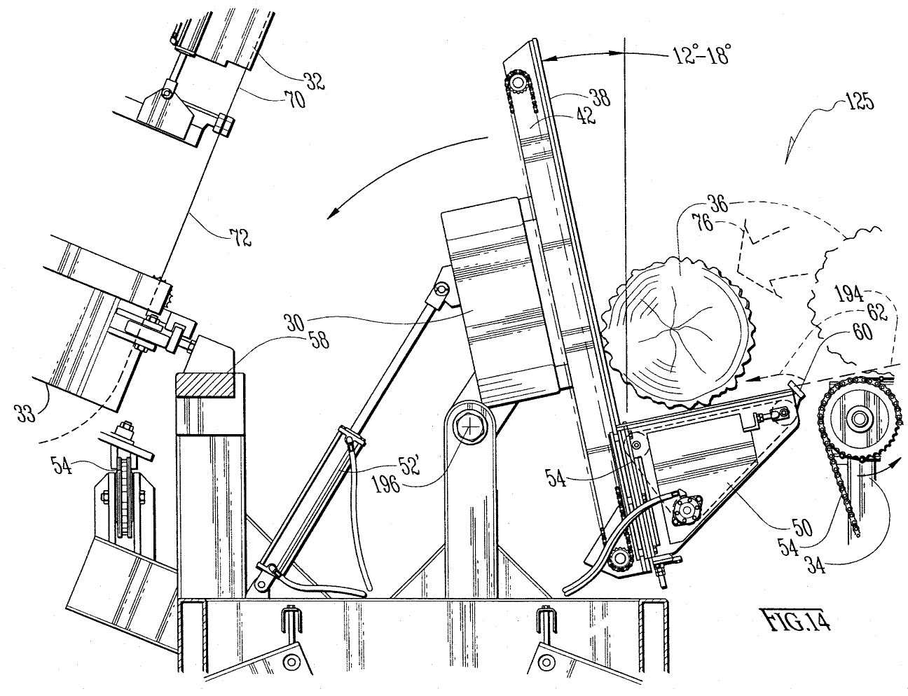

FIG. 3A is a reproduction of FIG. 3 hereof showing the sawmill (25) in accordance with the invention given the same labeling treatment as the counterpart prior art sawmill shown in FIGS. 1A-1D (eg., U.S. Pat. No. 4,341,248—Critchell et al.) as well as the same labeling treatment in the counterpart prior art cutting apparatus shown in FIGS. 3B-3E (eg., U.S. Pat. No. 5,579,671—Bowlin);

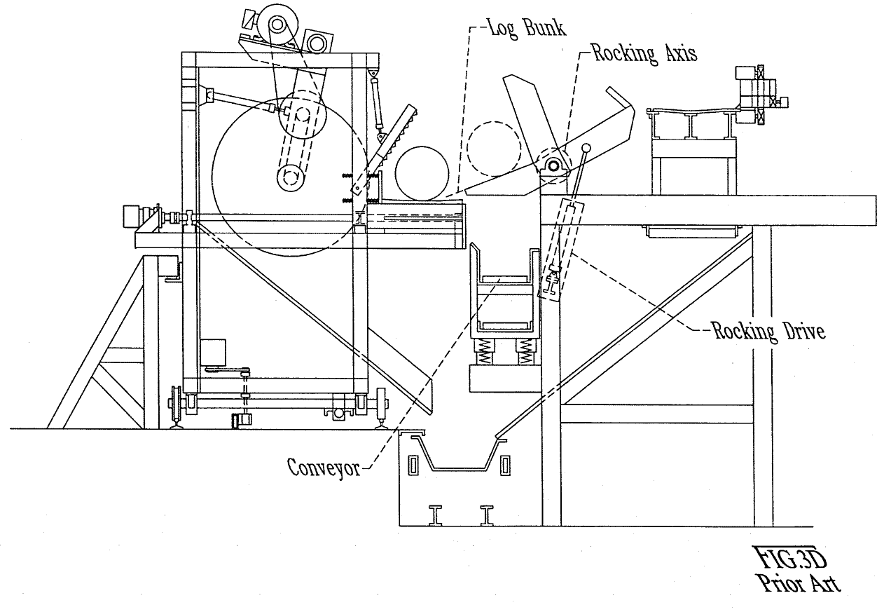

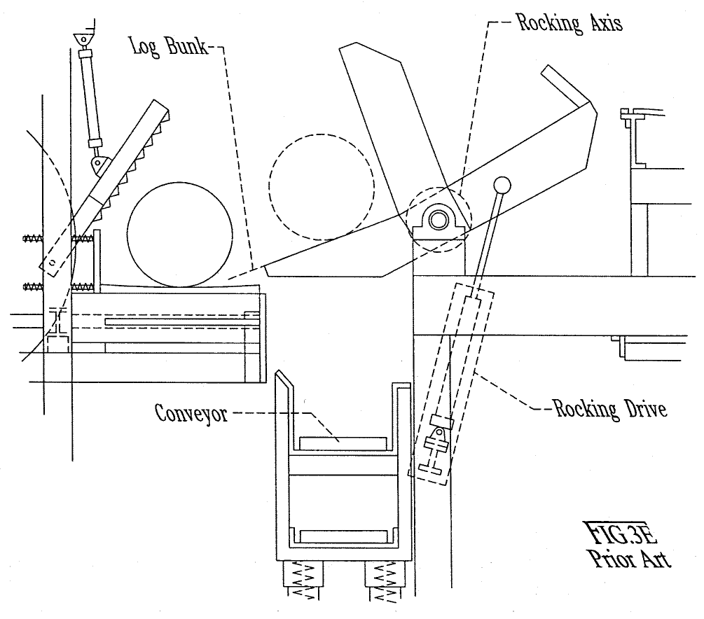

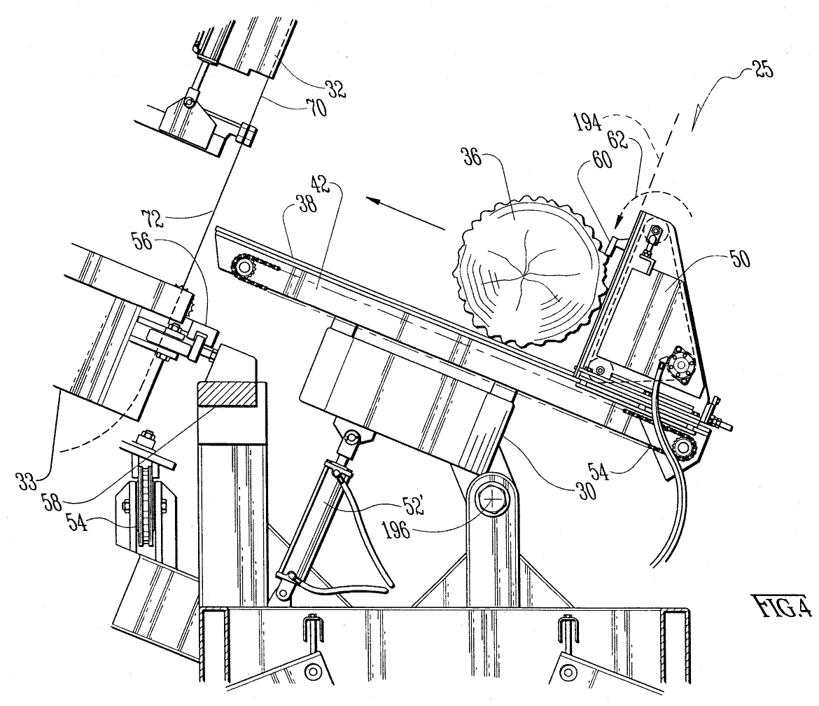

FIG. 3B is a reproduction of FIG. 3 in U.S. Pat. No. 5,579,671—Bowlin, except from a perspective on the opposite side of the cutting apparatus of Bowling, so that thereby the flow direction of a fresh log from the infeed side to the side where the saw operations are executed are correspondingly right to left as is the case with all other side views among FIGS. 1-8 hereof (and thus that would exclude the top view, FIG. 2 hereof), wherein this FIG. 3B is a side elevation view counterpart to FIG. 1 hereof,

FIG. 3C is an enlarged-scale side elevation view of the central portions of FIG. 3B;

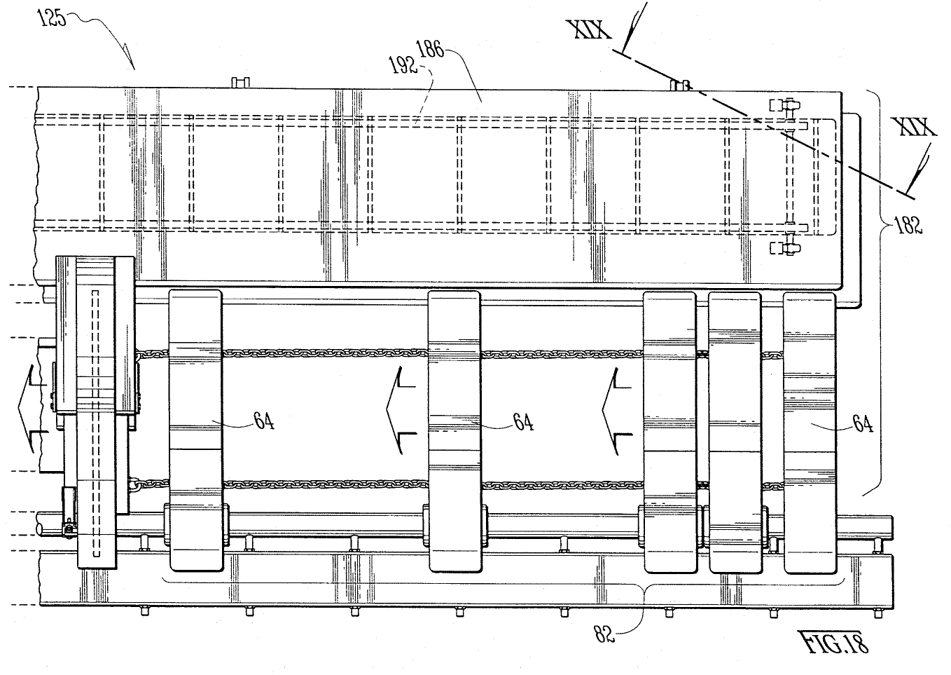

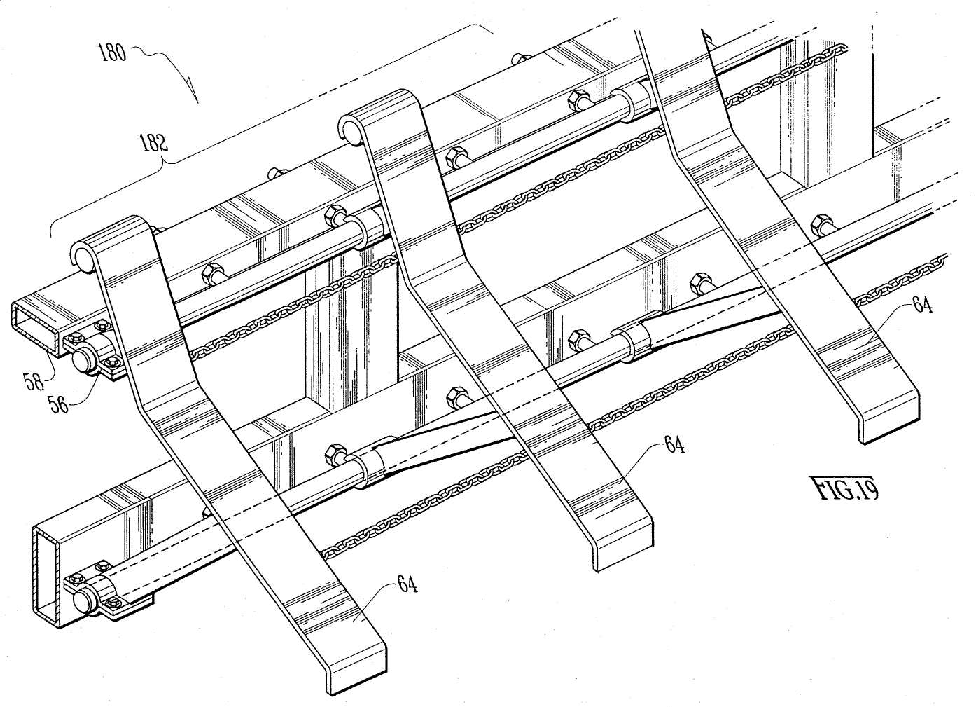

FIG. 3D is a reproduction of FIG. 2 in U.S. Pat. No. 5,579,671—Bowlin, except from a perspective on the opposite side of the cutting apparatus of Bowling, so that thereby the flow direction of a fresh log from the infeed side to the side where the saw operations are executed are correspondingly right to left as is the case with all other side views among FIGS. 1-8 hereof (and thus that would exclude the top view, FIG. 2 hereof), wherein this FIG. 3D is approximately a side elevation view counterpart to FIG. 5 hereof;

FIG. 3E is an enlarged-scale side elevation view of the central portions of FIG. 3D;

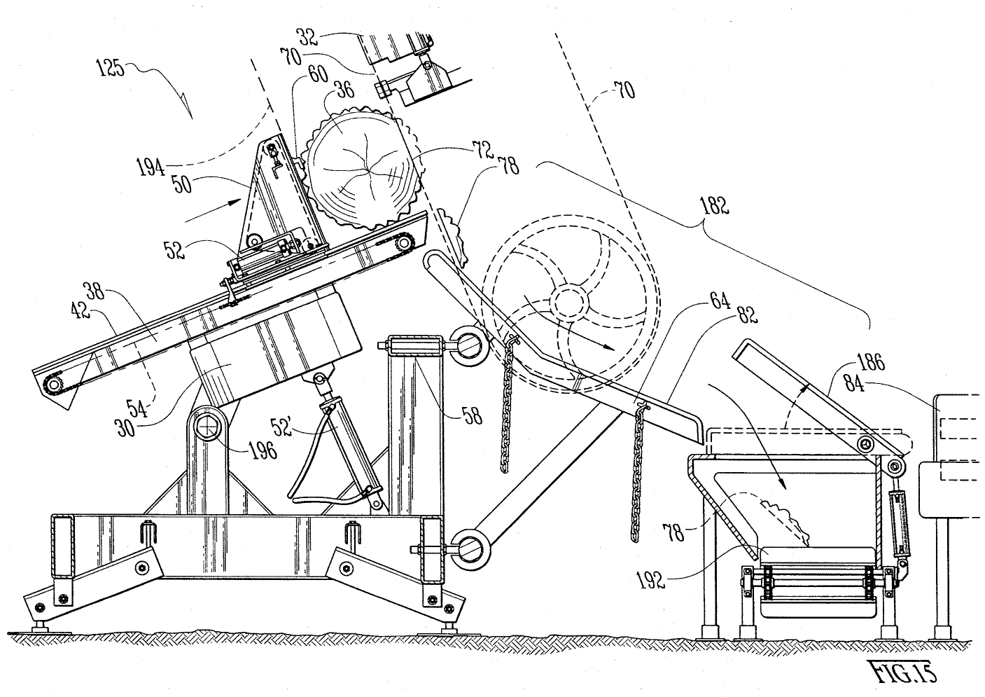

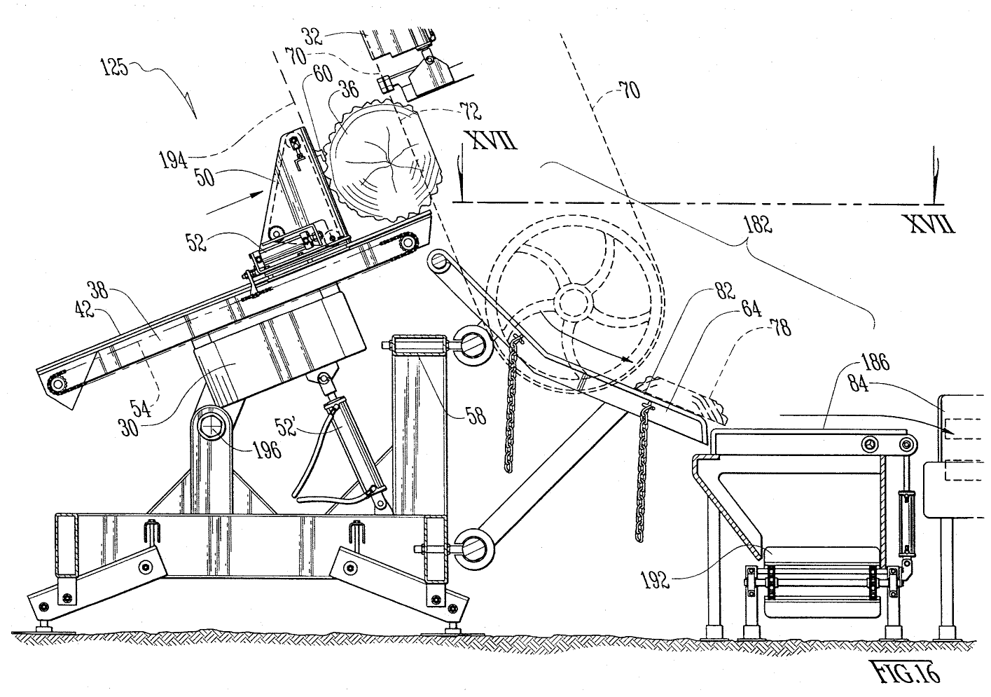

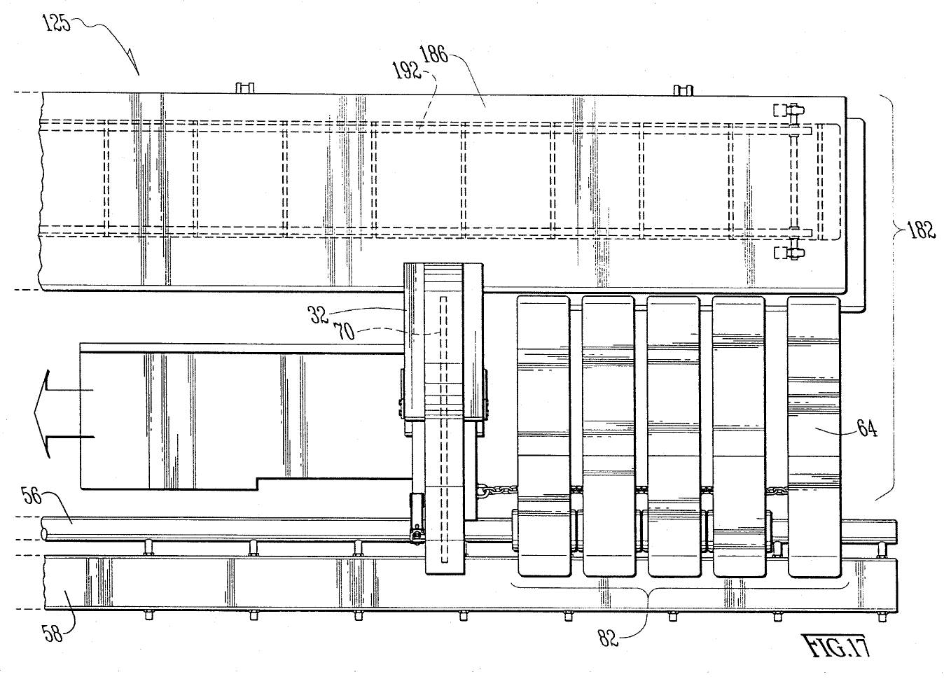

FIG. 4A is a reproduction of FIG. 4 hereof showing the sawmill (25) in accordance with the invention given the same labeling treatment as the counterpart prior art sawmill shown in FIGS. 1A-1D (eg., U.S. Pat. No. 4,341,248—Critchell et al.) as well as the same labeling treatment in the counterpart prior art cutting apparatus shown in FIGS. 3B-3E (eg., U.S. Pat. No. 5,579,671—Bowlin);

FIG. 5A is a reproduction of FIG. 5 hereof showing the sawmill (25) in accordance with the invention given the same labeling treatment as the counterpart prior art sawmill shown in FIGS. 1A-1D (eg., U.S. Pat. No. 4,341,248—Critchell et al.) as well as the same labeling treatment in the counterpart prior art cutting apparatus shown in FIGS. 3B-3E (eg., U.S. Pat. No. 5,579,671—Bowlin);

FIG. 9 is a top plan view comparable to FIG. 2 except showing the bandsaw (32) in a further left position, and having passed through the chucked log (36), wherein this FIG. 9 further shows the operation of the outflow conveyor system (80) for conveying away sawn off planks (78);

FIG. 10 a side elevation view comparable to FIG. 4 except taken from a right-side vantage point, and not a left-side vantage point;

FIG. 11 is an enlarged-scale elevation view of detail XI-XI in FIG. 10;

FIG. 12 is a side elevation view comparable to FIG. 1 except showing the rocking carriage (30) at a time before it tips back to pick up another log (36); and

FIG. 13 is an enlarged scale perspective view of a single one of the plurality of head assemblies (50) in accordance with the invention, as representative of the others;

FIG. 14 is a left-side, side elevation view, partly in section and comparable to FIG. 3, except of a second embodiment of a sawmill (125) in accordance with the invention equipped with the rocking carriage (30) as well as a second embodiment of an outflow conveyor system (180) in accordance with the invention, and showing that the series of frame members (38) that cooperatively form the tilting log bunk (42) of the rocking carriage (30) is in this view tilted to approximately between 12° and 18° shy of vertical;

FIG. 15 right-side, side elevation view, comparable to FIG. 10 except of the second embodiment of the sawmill (125) in accordance with the invention and the second embodiment of the outflow conveyor system (180) in accordance with the invention, wherein the lid (186) of a channel (188) that houses a waste conveyor (192) is tipped up to catch a waste slice of lumber (78), probably due to high bark content or the like, presumably to be conveyed away to a chipper or the like (not shown), and showing the series of frame members (38) that cooperatively form the tilting log bunk (42) of the rocking carriage (30) tilted to preferably 22.5° from horizontal;

FIG. 16 is right-side, side elevation view, comparable to FIG. 15 except showing a sawn-off plank (78), worthwhile for keeping, about to slide down the downslide (82) and then across the closed lid (186) of the channel (188) housing of the waste conveyor (192) to land on the production line conveyor (84), presumably to be conveyed away to a plainer or the like (not shown), wherein the downslide (82) has an upper steep portion preferably inclined at 45° from horizontal and a lower shallower portion preferably inclined at 22.5° from horizontal;

FIG. 17 is a top plan view taken in the direction of arrows XVII-XVII in

FIG. 16 and showing that the downslide (82) comprise a plurality of spaced apart slender ribs (64);

FIG. 18 is a top plan view comparable to FIG. 17 except showing that the plurality of spaced apart slender ribs (64) that make up the downslide (82) can telescope apart behind the traversing bandsaw 32, which is traveling to the left in this view;

FIG. 19 is a rear perspective view taken in the direction of arrows XIX-XIX in FIG. 18, wherein the plurality of spaced apart slender ribs (64) that make up the downslide (82) are shown in the fully expanded (open) state;

FIG. 20 is a reduced scale top plan view comparable to FIG. 18 except showing not only a closed lid (186) that covers the channel (188) housing for the waste conveyor (192) for waste slices (78) but also showing the production line conveyor (84) for other-than-waste product (78), wherein the plurality of spaced apart slender ribs (64) that make up the downslide (82) are shown in the fully expanded (open) state;

FIG. 21 is a top plan view comparable to FIG. 20 except showing that the outflow conveyor system (180) in accordance with the invention comprises both a left-side downslide (82) and right-side downslide (82), each comprising a plurality of spaced apart slender ribs (64) that can be telescoped between fully expanded (open) extremes, as shown by the right-side downslide (82), and, fully foreshortened (shut) extremes, as shown by the left-side downslide (82), wherein the opposing downslides telescope out to open, and foreshorten back to shut, in opposition to each other and in correspondence with the traverse of the bandsaw (32);

FIG. 22 is a top plan view comparable to FIG. 21 except showing the reverse state of the left- and right-side telescoping downslides (82), wherein the right-side downslide (82) is shown in its fully foreshortened (shut) state and left-side downslide (82) shown in its fully telescoped open state;

FIG. 23 is a stylized, cartoon-like rendition of left-side elevation view FIG. 5A wherein each of the five hydraulic drive cylinders (52′) for each of the five respective assemblies of parallel rocking carriages (30) and five respective parallel pairs of frames (38) (that cooperatively define the tilting log bunk (42)) shown in top plan FIG. 2 are fanned apart to show indeed that there are five such cylinders (52′), and that each of the five parallel pairs of frames (38) is tilted by their own independent drive cylinder (52′), whereby the parallel pairs of frames (38) can either be tilted in unison to form a planar bunk or titled differentially to provide an uneven bed, as for accommodating a log (36) that is less cylindrical and perhaps more tapered;

FIG. 24 is a stylized, cartoon-like left-side elevation view comparable to FIG. 23 except for showing replacement of the hydraulic drive cylinders (52′) shown in FIG. 23 as being replaced by independent mechanism drives (52″) (eg., flywheel and linkage pivoted to both the flywheel) and the respective assembly of the five respective parallel rocking carriages (30) and five respective parallel pairs of frames (38) (that cooperatively define the tilting log bunk (42)), wherein FIG. 24 furthermore stylistically shows that the series of five parallel pairs of frames (38) are given a small differential angle of tilt among each other in order to give impression of a non-planar arrangement of repose that defines the log bunk;

FIG. 25 is a stylized, cartoon-like left-side elevation view comparable to FIG. 24 except for showing replacement of the by independent mechanism drives (52″) in FIG. 24 with independent rack-and-pinion tilting drives (52′″) (there are still five independent rack-and-pinion tilting drives (52′″)) in number albeit not shown as in the manner of FIGS. 23 and 24, and the five independent rack-and-pinion tilting drives (52′″) are still independently operable; and

FIG. 26 is a stylized, cartoon-like left-side elevation view comparable to FIG. 25 except for showing replacement of the by independent rack-and-pinion drives (52′″) in FIG. 25 with independent chain or cable system tilting drives (52″″) (there are still five such chain or cable drive systems (52″″)) in number albeit not shown as in the manner of FIGS. 23 and 24, and the chain or cable systems (52″″) are still independently operable.

### DETAILED DESCRIPTION OF THE PREFERRED EMBODIMENTS

FIGS. 1 and 2 show a sawmill 25 in accordance with the invention.

The sawmill 25 comprises:
a rocking carriage 30;
a bandsaw 32;
an infeed log deck 34; and
an outflow conveyor system 80.

Infeed log deck 34 is loaded with a supply of logs 36 to feed to the rocking carriage 30. The infeed log deck 34 is shown for example and without limitation as comprising a chain-driven, chain conveyor belt.

The rocking carriage 30 comprises:
a series of spaced pairs of parallel frame members 38;
the frame members 38 cooperatively forming a tilting log bunk 42;
a series of head assemblies 50, each associated with one pair of frames 38;
various tilt/rocking drive systems 52′, 52″, 52′″ and 52″″ (including control thereover by sawmill control system 140);
various chain (and sprocket) drive systems 54;
perhaps other drive systems such as rack-and-pinion 56; and
as shown better in FIG. 2, various cross members 58;
   and so on and among other things.

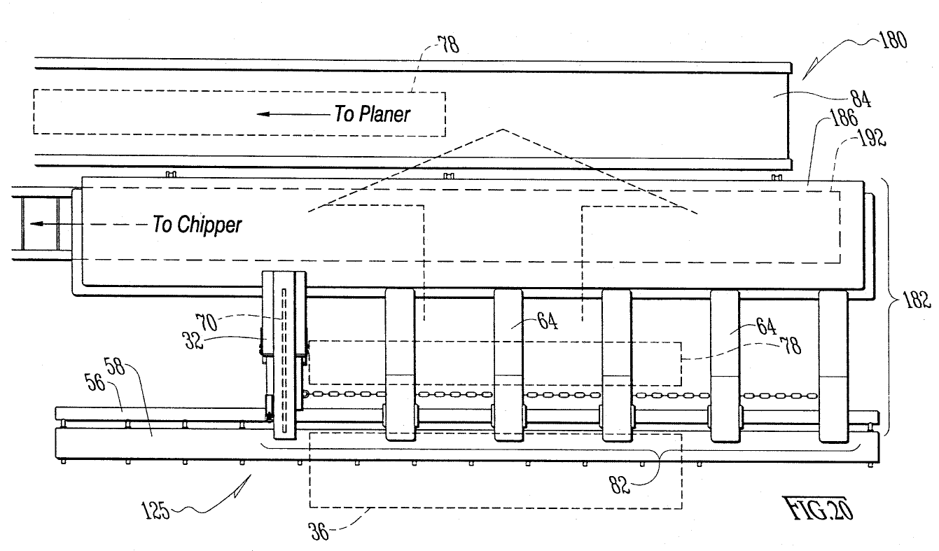

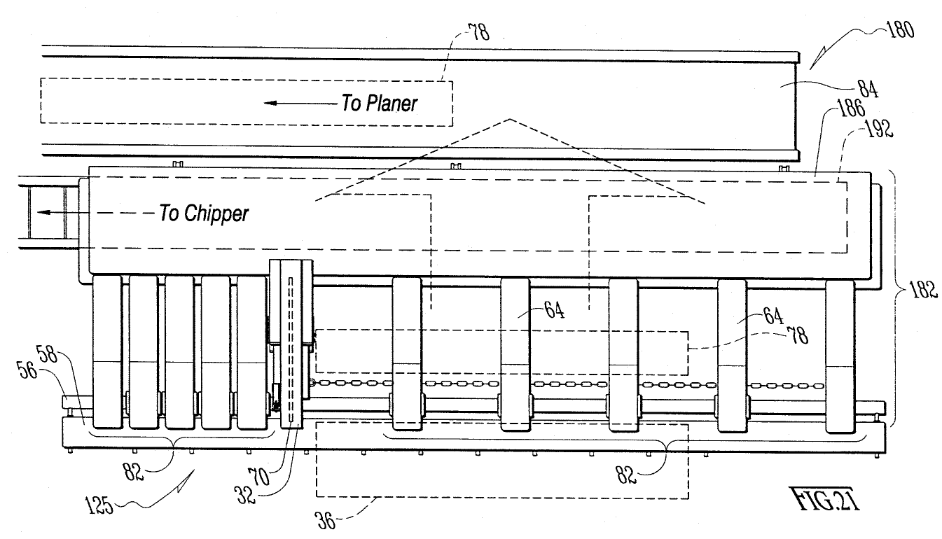

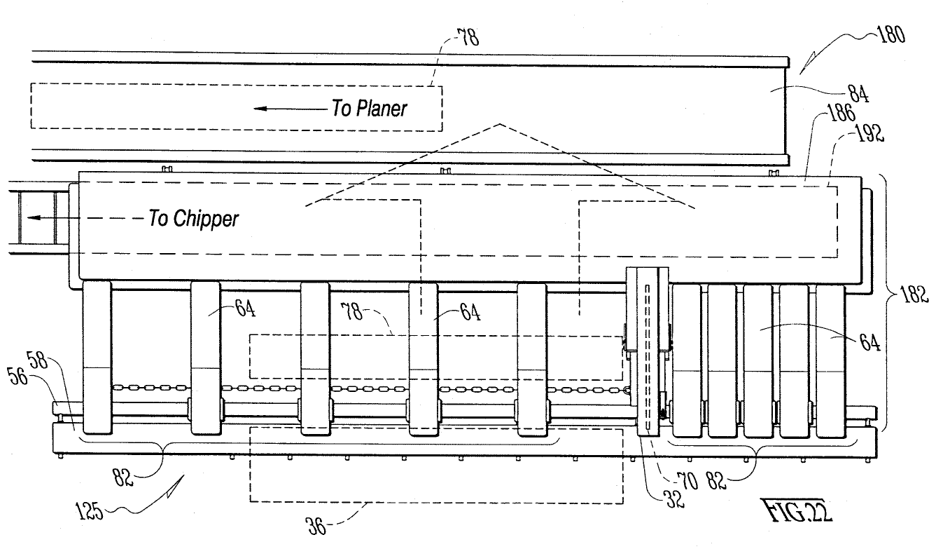

Each head assembly 50 has:
a dog 60.
   The dog 60 can be likened to a hay hook or a tooth. FIG. 4 shows the dog 60 being driven counter-clockwise (CCW) as indicated by broken-line arrow 62. In contrast, FIG. 6 shows the arrow 62 for indication the travel direction of the dog 60 being clockwise (CW). The dog 60 can driven in a full 360° orbit about the periphery of the head assembly 50 in a square-D shaped orbit.

FIG. 1 shows a series of logs 36 piled on the infeed log deck 34 for feeding to the rocking carriage 30. The log bunk 42 is empty. The bandsaw 32 is mounted on a traveling carriage 33 and can be driven reversibly into and out of the view of FIG. 1 (ie., reversibly left and right in FIG. 2). FIG. 2 shows the bandsaw 32 in the extreme right position (eg., ‘right’ given the orientation of the view), which can be assigned to be a relative ‘home’ position for the bandsaw 32 when the log bunk 42 is tilted up as shown. The ‘home’ position is the start position for the bandsaw 32 if the saw blade 70 only has teeth on the left edge thereof (eg., ‘left’ given the orientation of the view).

The log bunk 42 is defined by the parallel pairs of frames 38 on which the head assemblies 50 are coupled and driven cyclically between a rear, log infeed position for the log bunk 42 and forward (front) saw operation-positions relative a front edge for the log bunk 42. The parallel pairs of frames 38 are cooperatively tilted back and forth (eg., rocked seesaw style) by a variety of different drive systems 52′, 52″, 52′″ and 52″″.

FIGS. 1, 3 and 4-8 show that each pair of parallel frames 38 is served by a double-acting hydraulic cylinder 52′ having an upper pivot connection to the respective pair of parallel frames 38 and a lower pivot connection with a common support framework. That is, the rocking carriage 30, bandsaw 32 and traveling carriage 33 are mounted on a common support framework (as well as among other components, but not the infeed log deck 34 nor the laterally-conveying outflow conveyors, eg., 192). FIGS. 24-26 show alternate tilt (N rocking) drive systems 52″, 52′″ and 52″″. All drive systems 52′, 52″, 52′″ and 52″″ are coordinated by sawmill electronic control system 140 based on inputs from operator controls 148.

FIG. 1 shows the beginning of time for loading a log 36 onto the log bunk 42. FIG. 2 shows the end-result of loading a log 36 onto the log bunk 42 (albeit the log 36 in FIG. 2 is shown in dashed lines).

FIGS. 3-8 (excluding FIGS. 3A-3E, 4A and 5A) comprise a slide show that illustrates the progression of loading a log 36 onto the log bunk 42 and producing sawn-off slices or planks 78, wherein FIG. 2 corresponds to a time corresponding to FIG. 3.

In FIG. 3, the bandsaw 32 is mounted on a traveling carriage 33 and can be driven reversibly into and out of the view of FIG. 1 such that the saw blade 70 will travel reversibly into and out of the view in a plane indicated by the line given the reference numeral 72 (ie., same line for saw blade 70). In FIG. 2, the head assemblies 50 are aligning the tapered log 36 such that the outboard presentation of the log 36 to the plane 72 of the travel of the saw blade 70 is oriented in a parallel plane 74 (to the extent possible, given that tree trunk shapes can be highly irregular, especially so for hardwoods more than for, eg., pine).

Again, the rocking carriage 30, bandsaw 32 and traveling carriage 33 are mounted on a common support framework (as well as among other components, but not the infeed log deck 34 nor the laterally-conveying outflow conveyors, eg., 192).

The traveling carriage 33 and common support framework have mutually cooperating carrying and guiding travel ways for the traveling carriage 33 to be driven reversibly into and out of the view of FIG. 1 such that the saw blade 70 will travel reversibly into and out of the view in a plane indicated by the line given the reference numeral 72 (ie., same line for saw blade 70), and at the selected angle of inclination. The travel ways can include laterally elongated, vertically-spaced upper and lower provisions. That is, such as an upper provision that drives the out and back travel (eg., chain or cable drive systems as in any of FIG. 1 or 26), and so on. And, such as a lower provision that is passive and merely provides inclination stabilization.

FIG. 3 shows that the infeed log deck 34 has served the lead log 36 of the row of logs 36 loaded upon the infeed log deck 34 onto the rocking carriage 30 or, more particularly, into the bottom of the up-tilted corner formed by the log bunk 42 and head assemblies 50. (Recall, the log bunk 42 is defined by the series of parallel pairs of frame members 38, of which there are disclosed for example and without limitation to be five such parallel pairs of frame members 38).

FIG. 4 shows that the rocking carriage 30 including the log bunk 42 and head assemblies 50 thereof have pivoted CCW such that the log bunk 42, albeit at an incline, is perpendicular to the saw blade 70, which is also inclined. The dog 60 has been driven CCW into the outer skin (eg., bark) of the log 36 to get a ‘bite’ or a ‘clamp’ thereon.

FIG. 5 shows the head assemblies 50 presenting the log 36 for a first pass through by the saw blade 70, and perhaps a second pass. In FIG. 5, the head assemblies 50 would be indexed in incremental steps for the purpose of sawing a succession of passes, as for sawing planks. The slices 78 of each log 36 containing a lot of the outer skin (eg., bark) is likely discarded as waste or, at best, sent to a chipper or the like. Deeper cuts into the heart of the log 36 are better likely to produce planks 78 or beams and the like worthwhile for keeping for perhaps plaining and drying as well as other secondary treatments.

Preferably the saw blade 70 has teeth on both sides so that the saw blade 70 can have both an outbound path away from the home position and a reverse inbound path back to the home position. That way, the traveling carriage 33 carrying the bandsaw 32 does not have to make a wasteful return pass where it is not sawing the log 36. That is shown better in connection with FIGS. 21 and 22.

FIG. 6 shows the dog 60 in the process of being driven in a full CW orbit, as indicated by arrow 62, to come up underneath the log 36 and roll it a quarter of a roll CCW to land the log 36 on its flat surface.

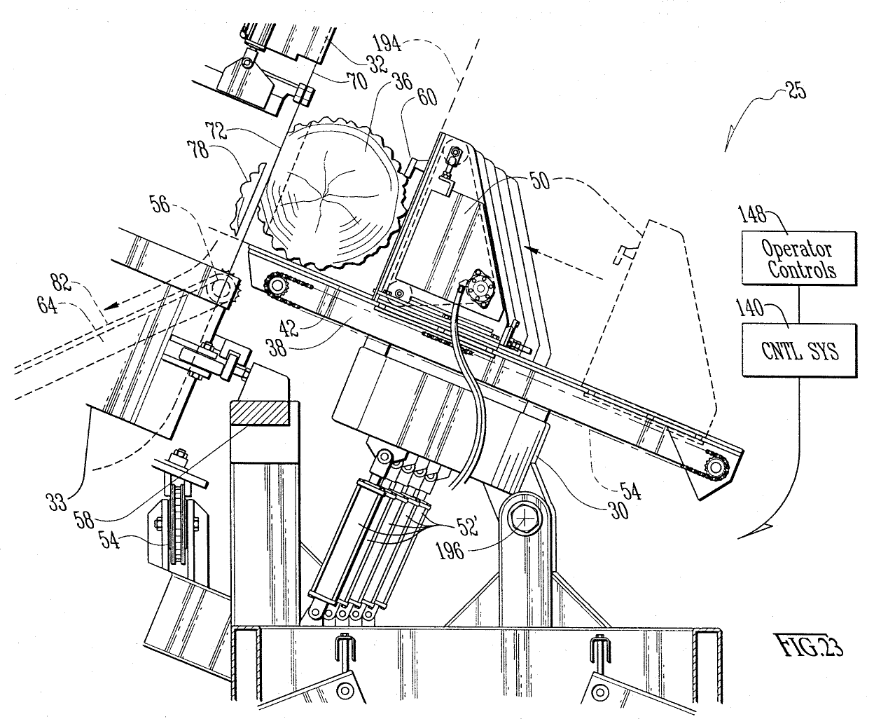

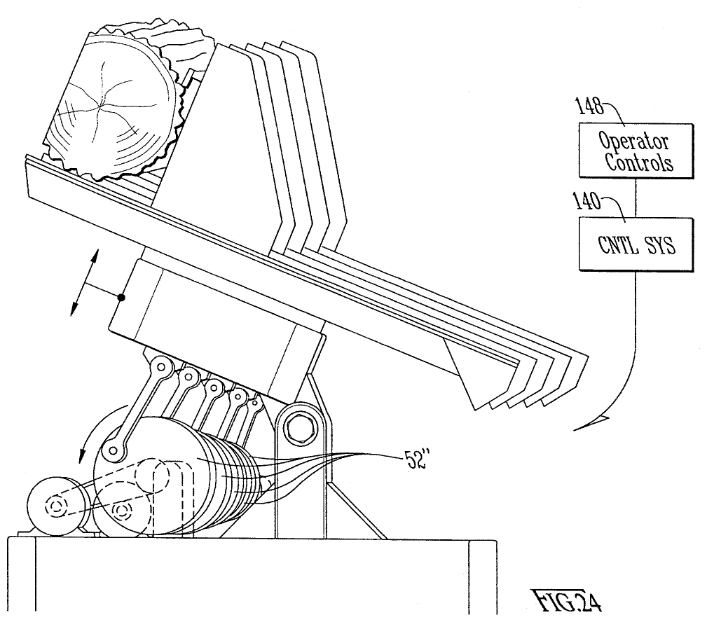

FIG. 7 shows that indeed the log 36 has landed on its flat face (ie., its only flat face so far at this stage). The dog 60 will be reversed (eg., driven CCW in this view, as indicated by arrow 62) and thus driven to get a fresh ‘bite’ or ‘clamp’ on the log 36.

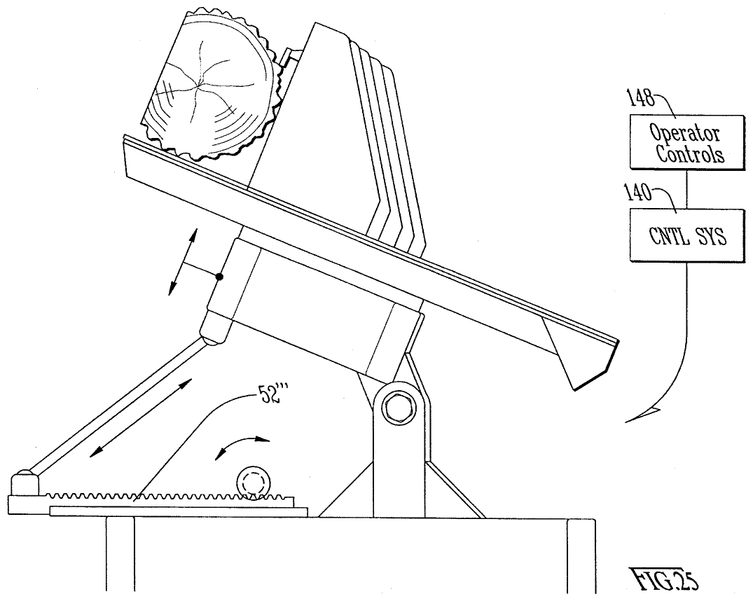

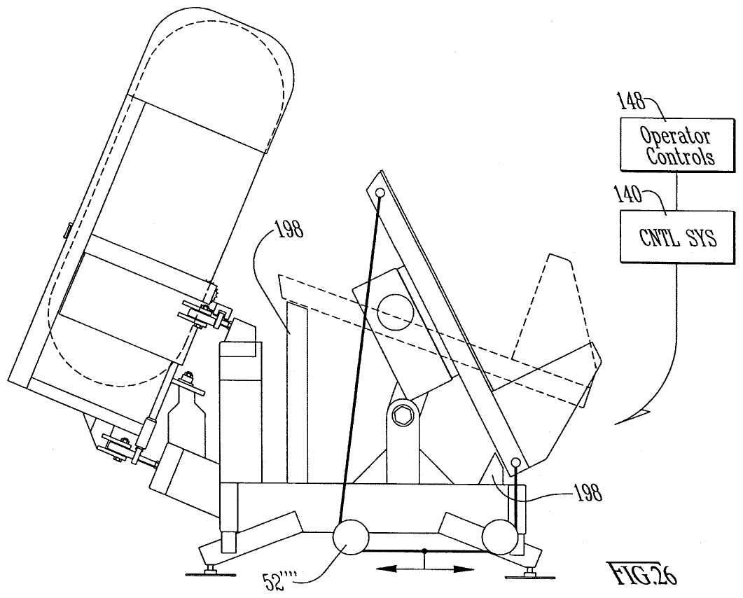

FIG. 8 shows that this manipulation between the dog 60 and head assembly 50 can continue, and roll the log 36 several times, until about the largest-size quadrilateral beam that can be produced from the log 36 is obtained. If wanted, users can slice this beam away to planks 78 or do otherwise.

FIG. 9 shows operation of the outflow conveyor system 80 in accordance with the invention for automatically conveying away sawn off planks 78 (or waste strips or slices 78, and perhaps even valuable beams, etc.).

More particularly, the outflow conveyor system 80 comprises:
a series of parallel ribs 64 forming a downslide 82;
an outflow log deck 84;
various chain (and sprocket) drive systems 54; and
perhaps other drive systems such as rack-and-pinion.
   The outflow log deck 84 is shown for example and without limitation as comprising a chain-driven, chain conveyor belt.

Comparing FIG. 2 to FIG. 9 shows that the series of parallel slender ribs 64 forming the downslide 82 are not static but dynamic. The ribs 64 can be telescoped between expanded apart (open) and foreshortened (shut) extremes. This can be likened to the ribs 64 (that form the downslide 82) being moved apart from one another to form the expanded extreme (as shown in FIG. 9), in the style of any of the following, eg.:—
a festooned cable system,
a buffers and chain coupler system ala 19^{th} Century European railroad cars,
a transverse-rod style of curtains/drapes,
a series of telescoped sleeves or drawer slides,
lazy tongs,
roll-up (N roll-out) tonneau covers (eg., re-purposed pick-up truck bed covers), and so on.

The drawings show for example and without limitation a version of ‘transverse-rod style of curtains/drapes.’ A more familiar example that would share similarity with how the series of parallel slender ribs 64 forming the downslide 82 can be telescoped between expanded apart (open) and foreshortened (shut) extremes might simply be, shower curtains.

There are just three components to make shower curtains easily swished open and closed:—(1) a shower curtain, (2) a shower curtain rod, and (2) a series of rings which the shower curtain rod threads through and which are dispersed along the top edge of the shower curtain at spaced intervals thereby, not only suspend (eg., support) the shower curtain, but also enable the telescopic operation between expanded apart (in the opposite example here, this would be shut) and foreshortened (and again, in the opposite example here, this would be shut) extremes. FIG. 19 shows for example and without limitation a laterally elongated pair of such support rods (vertically space apart, as well as, horizontally spaced apart in the flow direction of log 36 infeed to saw operations). FIG. 19 further shows rings structures which passively travel inbound and outbound on the support rods.

The ribs 64 can be wholly passive and arranged to be dragged apart and pushed back together by the out and back traversing of the bandsaw 32. Alternatively, the ribs 64 can be driven by means other than the pull and push of the bandsaw 32, and within synchronization with the traversing of the bandsaw 32. For example and without limitation, this could include linear drive nuts of the UHING® corporation of Flintbek, Germany. FIG. 19 shows the ribs 164 being arranged to be moved by the tug and the ramming of the bandsaw 32 as it goes back and forth, with no further drive assistance. However, if the ribs 64/164 were coupled by telescoping sleeves or lazing tongs and the like, the ribs could be driven independent of the pull or push of the bandsaw 32, and controlled independently as well.

FIG. 19 shows that the ribs 164 are tugged apart by a festooning chain, and would be collapsed back together by the compression from the returning bandsaw 32.

FIGS. 17 through 22 show better the expansion (to open) strokes and foreshortening (to shut) strokes of the ribs 164.

FIG. 2 shows the shut extreme for the parallel ribs 64 that form the downslide 82. All the ribs 64 are closely spaced together. FIG. 9 shows a relatively open extreme. All the ribs 64 are relatively spaced apart.

The rightmost rib 64 (“right” given the orientation of FIGS. 2 and 9) is fixed. All the other ribs 64 are movable. In FIG. 2, the ribs 64 are all telescoped to a relatively foreshortened (and shut) state. In FIG. 9, the ribs 64 are telescoped apart to a relatively open state. It is an aspect of the invention that the ribs 64 present no impediment to the travel of the bandsaw 32 and/or saw blade 70. To the contrary, the arms 64 always remain in a clear of the bandsaw 32, regardless if the bandsaw 32 is traveling left or right.

However, in FIGS. 2 and 9, the ribs 64 always provide the trailing space behind the bandsaw 32—as it travels outbound—collectively with a downslide 82. FIG. 10 shows one plank 78 or waste slice sliding down the downslide 82 to transfer onto and be conveyed away from there by outflow log deck 84.

FIGS. 11 and 13 show a double-acting hydraulic cylinder (actuator) 52 that advances one head assembly 50 ahead of a line of other head assemblies 50 (see FIG. 2) to true up the outboard presentation of the log 36 to plane 74.

FIG. 12 is a side elevation view comparable to FIG. 1 except showing the rocking carriage 30 empty of a log 36, and ready to rock back as shown in FIG. 1 and pick up another log 36 from the infeed log deck 34.

FIG. 14 is a left-side elevation view comparable to FIG. 3 except showing a second embodiment of a sawmill 125 in accordance with the invention equipped with the rocking carriage 30 as well as a second embodiment of an outflow conveyor system 180 in accordance with the invention. The tilting log bunk 42 of the rocking carriage 30 is shown in this FIG. 14 tilted to approximately between 12° and 18° shy of vertical.

FIG. 15 right-side elevation view comparable to FIG. 10 except of the second embodiment of the sawmill 125 in accordance with the invention and the second embodiment of the outflow conveyor system 180 in accordance with the invention. In this view, the lid 186 of a channel 188 that houses a waste conveyor 192 is tipped up to catch a waste slice of lumber 78. The waste slice of lumber 78 is likely regarded to be waste or low worth probably due to high bark content or the like. The waste slice of lumber 78 will presumably be conveyed away to a chipper or the like (not shown). In this FIG. 15, the tilting log bunk 42 of the rocking carriage 30 is shown tilted to preferably 22.5° from horizontal.

FIG. 16 is right-side elevation view comparable to FIG. 15 except showing a different sawn-off plank 78, worthwhile for keeping about to slide down the downslide 82 and then across the closed lid 186 of the channel 188 housing of the waste conveyor 192 to land on a regular, production line conveyor 84, presumably to be conveyed away to a planer or the like (not shown). The downslide 82 has an upper steep portion preferably inclined at 45° from horizontal and a lower shallower portion preferably inclined at 22.5° from horizontal.

FIG. 17 is a top plan view taken in the direction of arrows XVII-XVII in FIG. 16 and showing that the downslide 82 comprise a plurality of spaced apart slender ribs 64.

FIG. 18 is a top plan view comparable to FIG. 17 except showing that the plurality of spaced apart slender ribs 64 that make up the downslide 82 can telescope apart behind the traversing bandsaw 32, which is traveling to the left in this view.

FIG. 19 is a rear perspective view taken in the direction of arrows XIX-XIX in FIG. 18, wherein the plurality of spaced apart slender ribs 64 that make up the downslide 82 are shown in the fully expanded (open) state.

FIG. 20 is a reduced scale top plan view comparable to FIG. 18 except showing not only a closed lid 186 that covers the channel 188 housing for the waste conveyor 192 for waste slices 78 but also showing the production line conveyor 84 for other-than-waste product 78, wherein the plurality of spaced apart slender ribs 64 that make up the downslide 82 are shown in the fully expanded (open) state.

FIG. 21 is a top plan view comparable to FIG. 20 except showing that the outflow conveyor system 180 in accordance with the invention comprises both a left-side downslide 82 and right-side downslide 82. Each downslide 82 comprises a plurality of spaced apart slender ribs 64 that can be telescoped between fully expanded (open) extremes, as shown by the right-side downslide 82, and, fully foreshortened (shut) extremes, as shown by the left-side downslide 82. In use, the opposing downslides 82 telescope out to open, and foreshorten back to shut in opposition to each other and in correspondence with the traverse of the bandsaw 32 back and forth.

FIG. 22 is a top plan view comparable to FIG. 21 except showing the reverse state of the left- and right-side telescoping downslides 82, wherein the right-side downslide 82 is shown in its fully foreshortened (shut) state and left-side downslide 82 shown in its fully telescoped (open) state.

### I

Pause can be taken to summarize various advantages of this sawmill 25 and 125 in accordance with the invention. The rocking carriage 30 alone provides several advantages as explained next.

It should be recalled that, the rocking carriage 30 comprises the log bunk 42, which serves as the primary support deck for a log 36 during saw operations. The log bunk 42 is preferably configured as a spaced plurality of parallel pairs of frames 38. Each parallel pair of frames 38 has a head assembly 50 coupled on top of them to translate over them between forward and rearward positions. This plurality of head assemblies 50 serve as an upright backstop from the plane of the log bunk 42, and serve as a primary backstop for the log 36 supported on the log bunk 42. Thus the head assemblies 50 collectively define a backstop surface contained in a plane 194 that is more or less perpendicular to the plane of the log bunk 42.

The plane of the log bunk 42 is the plane collectively defined by the spaced plurality of parallel pairs of frames 38 upon which the log 36 is supported.

The rocking carriage 30 is arranged to rock (pivot) clockwise (CW) and counterclockwise (CCW) between angularly spaced extremes about a rocking axis (pivot axis) 196 that is substantially spaced below the plane of the support surface of the log bunk 42 (or at least that is, when the plane of log bunk 42 is more or less coincident with level). The plane of the log bunk 42 and the plane 194 of the collective backstop surfaces of the head assemblies 50 define essentially a perpendicular L-shaped corner.

The rocking carriage 30 rocks back such that this L-shaped corner tips back on its vertex (ie., vertex of the L-shaped corner), and thereafter essentially can be viewed as a V-shaped trough. Albeit, as a “V” shape where the legs of the “V” are essentially perpendicular to each other. The V-shaped trough can be rocked back until the plane 194 containing the backstop of the head assemblies 50 is only a shallow angle from being level. That way, a fresh log 36 can be fed to the V-shaped trough by simply letting gravity roll the log 36 over the plane 194 of the collective backstop surfaces of the head assemblies 50 until checked stopped by the collective surfaces of the parallel frame members 38 that define the log bunk 42 (see, eg., FIG. 1, 3 or 14). That way, the rocking carriage can rock back to pick up a fresh log 36 and, other than an infeed conveyor 34, without assistance from any other powered device or mechanism:—gravity does the work.

It is preferred if this sawmill 25 and/or 125 is designed to accommodate an inclined bandsaw 32. The bandsaw has a saw blade 70 which runs in an endless loop between a sawing run (eg., straight course) and return run. The plane 72 of the sawing run of the saw blade 70 of the bandsaw 32 might be angled at (for example and without limitation) 22.5° from vertical. Given the foregoing, it is another aspect of the invention that the rocking carriage 30 rocks forward until (preferably, though not exclusively) the plane of the log bunk 42 forms a perpendicular angle with the plane 72 of the saw cut of the inclined saw blade 70. If the sawing plane 72 of the saw blade 70 is presumed to make a 22.5° angle with vertical, then accordingly the rocking carriage 30 would rock forward until the plane of the log bunk 42 forms a 22.5° angle with horizontal (ie., not vertical but horizontal). After that, the plurality of head assemblies 50 would incrementally translate forwardly in coordination with each other such that the plane 194 of the backstop surface defined thereby puts the log 36 to-be-sawn out into the path of the saw blade 70 by the selected thickness for the resulting sawn-off slice or plank 78.

Another advantage provided by the rocking carriage 30 includes the following. That is, the rocking carriage 30 can be intermittently rocked back in between selected saw cuts, not all the way back as when picking up a fresh new log 36, but back to where the legs of the V-shaped trough extend at 45° angles to horizontal. That way, the log 36 can be more easily manipulated to be rolled 90° (and as somewhat shown by FIGS. 6 and 7). The plurality collective of head assemblies 50 have dogs 60 (eg., hook projections) that can be driven in endless orbits in both clockwise (CW) and counterclockwise (CCW) directions. The orbit for each dog 60 is approximately a square-D shape or the like, such that the vertical run coincides with running up and down the plane 194 of the backstop defined by the plurality collective of head assemblies 50. The dogs 60 serve at least two different purposes. The primary purpose of the dogs 60 is to “bite” on top of the log 36 such that the log 36 is securely clamped (this is also referred to as “chucked”). This shown in FIGS. 4 and 5. But the dogs 60 can also be driven in a full orbit in reverse such that, when the rocking carriage 30 is tilted back to the 45° angle, the dogs 60 come in underneath the log 36 and roll it. The foregoing procedure is somewhat what is shown by FIGS. 6 and 7. Preferably this procedure is performed after the log 36 has been sawn once or twice and has at least one flat face. That way, when the dogs 60 come up underneath the log 36, the dogs 36 should knock the log over to roll 90° and land on the log 36's least one flat face. To get the log 36 to roll over, it might take a coordinated movement between the rocking carriage 30 rocking forward, to more or less throw the log 36 over, and running the dogs 60 up beneath behind the log 36, to give the log 36 an extra boost to get it to roll over.

Again, the V-shaped trough defined between the log bunk 42 and head assemblies 50 allows a fresh new log 36 to gently roll off the infeed log deck 34 roll and be caught in the V-shaped trough without another bumper guard. This is shown better in FIG. 14. Additionally, as described above, the V-shaped trough can be rocked back and forth about the 45° angle therefor in combination with (or coordination with) the orbiting dogs 60 to afford an easier means of rolling the sawn log 36 over onto flat faces. Given these two mechanisms (the rocking carriage 30 and its V-shaped trough being one, the reverse-orbiting dogs 60 being the other), users/operators can manipulate the log 36 on the log bunk 42 just about however they want.

It is still another aspect of the invention that ribs 62 of the downslide 82 are angled, configured and otherwise proportioned to ensure that the broad flat face of a sawn off plank 78 lands on the production line conveyor 84 face down, and not face up. This is shown in any of FIGS. 1, 12 and 16. To say this in reverse, it is an aspect of the invention to avoid having the narrow flat face of a sawn off plank 78 land face down. Again, what is wanted is the broad flat face of plank 78 landing face down on production line conveyor 84. In part this is achieved by making the downslide 82 a long slide, and a shallow slide at least at the lower end. Gravity is relied upon to do the work of sliding the sawn-off plank 78 onto the conveyor 84. The conveyor 84 is safely well out of the way of the transverse path of the traveling carriage 33 for the bandsaw 32, because the downslide 82 is a long slide. And, the conveyor 84 should safely catch the plank 78 with the broad face down because the tail of the downslide 82 comes in at a shallow angle. This is shown by any of FIGS. 1, 10, 12, 15 and 16. The downslide 82 is configured to likewise get safely out the way of the traversing bandsaw 32 by comprising a plurality of telescoping ribs 64. Again, gravity does the work of sliding the sawn-off plank 78 out of the way of the transverse path of the traveling carriage 33 for the bandsaw 32. The downslide 32 telescopes out and foreshortens shut with the traversing bandsaw 32 so as to also be safely out of the way.

It is yet another aspect of the invention to provide a telescoping downslide 82 that telescopes between expanding and foreshortening strokes with an inclined bandsaw 32 traversing back and forth. The telescoping downslide 82 enables the sawn-off plank 78 to slide out of the traverse path of the traveling carriage 33 of the bandsaw 32 while keeping itself (the telescoping downslide 82) out of harms way too.

It is an other aspect of the invention to provide such an inventive downslide 82 configuration particularly for an inclined bandsaw 32, regardless if the bandsaw 32 merely cuts on an outbound trip (eg., outbound from a home position, probably where a user/operator, maybe referred to as the ‘sawyer,’ is stationed to provide the primary manual inputs to the operator controls 148), and which bandsaw 32 returns without cutting on a return trip (N return stroke). However, it is even more preferred to provide the bandsaw 32 with a saw blade 70 that has teeth on both edges. That way, the bandsaw 32 can cut on the outbound trip, and then, cut again on the return trip (stroke).

It is moreover an aspect of the invention to provide a telescoping downslide 82 on both sides of the traversing bandsaw 32. One telescoping downslide 82 would be undergoing an expansion stroke while the other telescoping downslide 82 would be concurrently undergoing a foreshortening stroke, and vice versa, in alternation with each other.

### II

Various aspects and objects of the invention are provided by, including and without limitation, according to the following Statements.

Statement One. A sawmill for logs comprising:
a rocking carriage comprising a log bunk which extends longitudinally between a front edge proximate where saw operations are executed, and, a back edge proximate where fresh-log-infeed operations are executed, as well as which extends laterally between a left side and a right side, said log bunk defining a primary support bed for a log during saw operations;
a bandsaw mounted on a traveling carriage for traversing between left and right extremes in front of the front edge of the log bunk;
said rocking carriage further comprising a back stop assembly coupled with respect to the log bunk to translate over the primary support bed of the log bunk between forward and rearward extremes and presenting a backstop surface extending up and out from the primary support bed of the log bunk;
whereby the primary support bed of the log bunk and the backstop surface of the backstop assembly define a vertex which correspondingly moves between forward and rearward extremes with the back stop assembly;
said rocking carriage being arranged to rock forwardly and rearwardly between clockwise and counterclockwise extremes about a rocking axis; and
wherein the rocking axis is disposed remote from the front edge of the log bunk; and
further comprising a rocking drive-source drive-system that drives the rocking carriage between the clockwise and counterclockwise extremes;
said rocking drive-source drive-system being coupled to the rocking carriage between the front edge of the log bunk and the rocking axis.

Statement Two. The sawmill of Statement One, further comprising:
an outflow conveyor forming a downslide for conveying away sawn-off planks or other product after a saw operation;
wherein which downslide extends from an upper rear transfer edge in front of and level with or below the front edge of the log bunk to a lower forward outflow edge remotely forward of the upper rear transfer edge thereof and the front edge of the log bunk;
whereby the outflow conveyor is located elsewhere than:
   underneath the log bunk, as well as
   between the front edge of the log bunk and the rocking axis;
so that thereby the rocking drive-source drive-system can be disposed:
   not only underneath the log bunk, but also
   between the front edge of the log bunk and the rocking axis.

Statement Three. The sawmill of Statement Two, wherein:
the downslide comprises series of parallel ribs.

Statement Four. The sawmill of Statement Four, wherein:
the rocking-drive source drive-system comprises at least any of:
   a system comprising one or more hydraulic cylinder systems;
   a system comprising one or more cable or chain-and-sprocket drive systems;
   a system comprising one or more rack-and-pinion drive systems; or
   a system comprising one or more mechanisms.

Statement Five. The sawmill of Statement One, wherein:
the rocking-drive source drive-system comprises a plurality of hydraulic cylinder systems; and
an electronic control system responsive to operator controls and in consequence thereof controlling the plurality of hydraulic cylinder systems.

Statement Six. The sawmill of Statement One wherein:
the bandsaw comprises a saw blade which makes saw cuts in a given plane of saw blade cutting travel; and
the bandsaw is carried by the traveling carriage therefor such that the given plane of saw blade cutting travel is tilted rearwardly to a shallow angle from vertical; and
said rocking carriage being arranged to rock forwardly such that the primary support bed of the log bunk is essentially at an angle complementary to the given plane of saw blade cutting travel, and, the backstop surface is essentially parallel to the given plane of saw blade cutting travel.

Statement Seven. The sawmill of Statement Six, wherein:
the downslide comprises series of parallel ribs;
the series of parallel ribs that form the downslide are mounted to travel in left to right strokes relative each other but whereby not as in full left to right traverses of the traveling carriage for the bandsaw.

Statement Eight. The sawmill of Statement Seven, wherein:
the series of parallel ribs that form the downslide extend from the upper rear transfer edges collectively thereof to the lower forward outflow edges collectively therefor such that the series of parallel ribs that form the downslide lie in the path of the blade of the bandsaw.

Statement Nine. The sawmill of Statement Eight, wherein:
the series of parallel ribs that form the downslide are divided into a left-side series of parallel ribs always on the left of the blade of the bandsaw and right-side series of parallel ribs always on the right of the blade of the bandsaw.

Statement Ten. The sawmill of Statement Nine, wherein:
the left-side series of parallel ribs are mounted and operable to telescopically expand and foreshorten as one collection between a fully-expanded apart extreme, in which the parallel ribs of the left-side series are relatively spaced apart from one another, and a fully-foreshortened extreme, in which the parallel ribs of the left-side series are relatively closer to or abutting one another; and
the right-side series of parallel ribs are comparably mounted and operable to telescopically expand and foreshorten as another collection between a fully-expanded apart extreme, in which the parallel ribs of the right-side series are relatively spaced apart from one another, and a fully-foreshortened extreme, in which the parallel ribs of the right-side series are shut or relatively shut with one another;
whereby the left-side series of parallel ribs and right-side series of parallel ribs can be operable to telescope expanded apart and foreshorten back to shut, or relatively shut, in opposition to one another and in correspondence with the traverse of the bandsaw back and forth such that the left-side series of parallel ribs and right-side series of parallel ribs avoid being sawn into by the blade of the bandsaw.

Statement Eleven. The sawmill of Statement Ten, wherein:
either the left-side series of parallel ribs or the right-side series of parallel ribs, or both, telescope between expanded apart and foreshortened shut, or relatively shut, extremes by virtue of a festooned cable system.

Statement Twelve. The sawmill of Statement One, wherein:
the log bunk comprises series of spaced parallel frames; and
wherein the backstop assembly comprises a corresponding series of head assemblies that translate over the series of spaced parallel frames that form the primary support bed of the log bunk between forward and rearward extremes and presenting a cooperative backstop surface extending up and out from the primary support bed of the log bunk formed by the series of spaced parallel frames.

Statement Thirteen. The sawmill of Statement Twelve, wherein:
the log bunk comprises series of pairs of spaced parallel frames;
wherein the backstop assembly comprises a corresponding series of head assemblies; and
wherein each head assembly translates over a respective one of the pair of the series of spaced parallel frames.

Statement Fourteen. The sawmill of Statement Twelve, wherein:
the series of spaced parallel frames that form the log bunch are independently equipped with a respective rocking drive-source drive-system that drives a respective frame between the clockwise and counterclockwise extremes.

Statement Fifteen. The sawmill of Statement Fourteen, wherein:
the rocking-drive source drive-system comprises a series of independently operable hydraulic cylinder systems 52′; and further comprising an electronic control system 140 responsive to operator controls 148 and in consequence thereof controlling the independently operable hydraulic cylinder systems 52′.

Statement Sixteen. The sawmill of Statement Fourteen, wherein:
the rocking-drive source drive-system comprises a series of independently operable rack-and-pinion drive systems 52′; and
further comprising an electronic control system 140 responsive to operator controls 148 and in consequence thereof controlling the independently operable rack-and-pinion drive systems 52′.

Statement Seventeen. The sawmill of Statement Fourteen, wherein:
the rocking-drive source drive-system comprises a series of independently operable mechanism drive systems 52″; and
further comprising an electronic control system 140 responsive to operator controls 148 and in consequence thereof controlling the independently operable mechanism drive systems 52″.

Statement Eighteen. The sawmill of Statement Fourteen, wherein:
the rocking-drive source drive-system comprises a series of independently operable cable or chain-and-sprocket drive systems 52″″; and further comprising an electronic control system 140 responsive to operator controls 148 and in consequence thereof controlling the independently operable chain-and-sprocket drive systems 52″″.

Statement Nineteen. The sawmill of Statement Eighteen, further comprising:
forward and rearward prop fixtures 198 and 198 anchored underneath the log bunk and on a common ground with the rocking axis, said forward and rearward props fixtures 198 and 198 providing counter-clockwise and clockwise tilting/rocking limits on the log bunk and providing prop support to weight on the log bunk whereby the forward and rearward prop fixtures 198 and 198 provide support to a log when proximate the front edge proximate where saw operations are executed and proximate the rear edge proximate where fresh-log-infeed operations are executed.

Statement Twenty. The sawmill of Statement Nineteen, wherein:
the common ground comprises a common support framework.

FIG. 1A is a reproduction of FIG. 13 in U.S. Pat. No. 4,341,248—Critchell et al., which is a side elevation view counterpart to FIG. 1 hereof, wherein the flow direction of a fresh log from the infeed side to the side where the saw operations are executed are correspondingly right to left also. FIG. 1B is an enlarged-scale side elevation view of the left-half of FIG. 1A. FIG. 1C is a reproduction of FIG. 12 in U.S. Pat. No. 4,341,248—Critchell et al., which is a side elevation view counterpart to FIG. 5 hereof. FIG. 1D is an enlarged-scale side elevation view of the left-half of FIG. 1C.

These views show that the prior art apparatus of Critchell et al. dispose their rocking drive rear of the rocking axis, and proximate the rear edge which is proximate where the log-infeed operations are executed. Which is unlike applicant, who disposes his rocking drive forward of the rocking axis, and proximate the proximate edge which is proximate where the saw operations are executed.

Applicant's configuration more stably supports the log steadily because there is underneath support proximately underneath the log where the saw operations are executed. In contrast, with the Critchell et al. configuration, the front edge of the counterpart log deck is unsupported past the rocking axis, and thereby akin to a spring board. It is like a competitive diver on the spring diving boards, in preparation of back flips, gets the diving board oscillating (rocking) in order to get higher altitude for the dive.

Applicant seeks to constrain applicant's log deck in order that there are no equivalent such oscillations during saw operations. Applicant wants instead for the log to be very still during the pass of the saw blade.

FIG. 3B is a reproduction of FIG. 3 in U.S. Pat. No. 5,579,671—Bowlin, except from a perspective on the opposite side of the cutting apparatus of Bowling, so that thereby the flow direction of a fresh log from the infeed side to the side where the saw operations are executed are correspondingly right to left as is the case with all other side views among FIGS. 1-8 hereof (and thus that would exclude the top view, FIG. 2 hereof), wherein this FIG. 3B is a side elevation view counterpart to FIG. 1 hereof. FIG. 3C is an enlarged-scale side elevation view of the central portions of FIG. 3B. FIG. 3D is a reproduction of FIG. 2 in U.S. Pat. No. 5,579,671—Bowlin, except from a perspective on the opposite side of the cutting apparatus of Bowling, so that thereby the flow direction of a fresh log from the infeed side to the side where the saw operations are executed are correspondingly right to left as is the case with all other side views among FIGS. 1-8 hereof (and thus that would exclude the top view, FIG. 2 hereof), wherein this FIG. 3D is approximately a side elevation view counterpart to FIG. 5 hereof. FIG. 3E is an enlarged-scale side elevation view of the central portions of FIG. 3D.

Just like Critchell et al., and opposite of applicant, Bowlin disposes his rocking drive rear of the rocking axis, and proximate the rear edge which is proximate where the log-infeed operations are executed.

Unlike both applicant and Critchell et al., Bowlin does not execute his saw operations with the timber product supported on the counterpart log deg. The Bowlin counterpart log deck is a mere transfer conveyor, and not a combination support bed during saw operations.

FIGS. 3A, 4A and 5A are reproductions of FIGS. 3, 4 and 5 hereof respectively, showing the sawmill 25 in accordance with the invention given the same labeling treatment as the counterpart prior art sawmill shown in FIGS. 1A-1D (eg., U.S. Pat. No. 4,341,248—Critchell et al.) as well as the same labeling treatment in the counterpart prior art cutting apparatus shown in FIGS. 3B-3E (eg., U.S. Pat. No. 5,579,671—Bowlin).

### IV

FIG. 23 is a stylized, cartoon-like rendition of left-side elevation view FIG. 5A wherein each of the five hydraulic drive cylinders 52′ for each of the five respective assemblies of parallel rocking carriages 30 and five respective parallel pairs of frames 38 (that cooperatively define the tilting log bunk 42) shown in top plan FIG. 2 are fanned apart to show indeed that there are five such cylinders 52′, and that each of the five parallel pairs of frames 38 is tilted by their own independent drive cylinder 52′, whereby the parallel pairs of frames 38 can either be tilted in unison to form a planar bunk or titled differentially to provide an uneven bed, as for accommodating a log 36 that is less cylindrical and perhaps more tapered.

FIG. 24 is a stylized, cartoon-like left-side elevation view comparable to FIG. 23 except for showing replacement of the hydraulic drive cylinders 52′ shown in FIG. 23 as being replaced by independent mechanism drives 52″ (eg., flywheel and linkage pivoted to both the flywheel) and the respective assembly of the five respective parallel rocking carriages 30 and five respective parallel pairs of frames 38 (that cooperatively define the tilting log bunk 42), wherein FIG. 24 furthermore stylistically shows that the series of five parallel pairs of frames 38 are given a small differential angle of tilt among each other in order to give impression of a non-planar arrangement of repose that defines the log bunk.

FIG. 25 is a stylized, cartoon-like left-side elevation view comparable to FIG. 24 except for showing replacement of the by independent mechanism drives 52″ in FIG. 24 with independent rack-and-pinion tilting drives 52′″ (there are still five independent rack-and-pinion tilting drives 52′″) in number albeit not shown as in the manner of FIGS. 23 and 24, and the five independent rack-and-pinion tilting drives 52′″ are still independently operable.

FIG. 26 is a stylized, cartoon-like left-side elevation view comparable to FIG. 25 except for showing replacement of the by independent rack-and-pinion drives 52′″ in FIG. 25 with independent chain or cable system tilting drives 52″″(there are still five such chain or cable drive systems 52″″) in number albeit not shown as in the manner of FIGS. 23 and 24, and the chain or cable systems 52″″ are still independently operable.

### V

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. A sawmill for logs comprising:
a rocking carriage comprising a log bunk which extends longitudinally between a front edge proximate where saw operations are executed, and, a back edge proximate where fresh-log-infeed operations are executed, as well as which extends laterally between a left side and a right side, said log bunk defining a primary support bed for a log during saw operations;
a bandsaw mounted on a traveling carriage for traversing between left and right extremes in front of the front edge of the log bunk;
said rocking carriage further comprising a back stop assembly coupled with respect to the log bunk to translate over the primary support bed of the log bunk between forward and rearward extremes and presenting a backstop surface extending up and out from the primary support bed of the log bunk;
whereby the primary support bed of the log bunk and the backstop surface of the backstop assembly define a vertex which correspondingly moves between forward and rearward extremes with the back stop assembly;
said rocking carriage being arranged to rock forwardly and rearwardly between clockwise and counterclockwise extremes about a rocking axis; and
wherein the rocking axis is disposed remote from the front edge of the log bunk; and
further comprising a rocking drive-source drive-system that drives the rocking carriage between the clockwise and counterclockwise extremes;
said rocking drive-source drive-system being coupled to the rocking carriage between the front edge of the log bunk and the rocking axis.

2. The sawmill of claim 1, further comprising:
an outflow conveyor forming a downslide for conveying away sawn-off planks or other product after a saw operation;
wherein which downslide extends from an upper rear transfer edge in front of and level with or below the front edge of the log bunk to a lower forward outflow edge remotely forward of the upper rear transfer edge thereof and the front edge of the log bunk;
whereby the outflow conveyor is located elsewhere than:
underneath the log bunk, as well as
between the front edge of the log bunk and the rocking axis;
so that thereby the rocking drive-source drive-system can be disposed:
not only underneath the log bunk, but also
between the front edge of the log bunk and the rocking axis.

3. The sawmill of claim 2, wherein:
the downslide comprises series of parallel ribs.

4. The sawmill of claim 1, wherein:
the rocking-drive source drive-system comprises at least any of:
a system comprising one or more hydraulic cylinder systems;
a system comprising one or more cable or chain-and-sprocket drive systems;
a system comprising one or more rack-and-pinion drive systems; or
a system comprising one or more mechanisms.

5. The sawmill of claim 1, wherein:
the rocking-drive source drive-system comprises a plurality of hydraulic cylinder systems; and
an electronic control system responsive to operator controls and in consequence thereof controlling the plurality of hydraulic cylinder systems.

6. The sawmill of claim 1, wherein:
the bandsaw comprises a saw blade which makes saw cuts in a given plane of saw blade cutting travel; and
the bandsaw is carried by the traveling carriage therefor such that the given plane of saw blade cutting travel is tilted rearwardly to a shallow angle from vertical; and
said rocking carriage being arranged to rock forwardly such that the primary support bed of the log bunk is essentially at an angle complementary to the given plane of saw blade cutting travel, and, the backstop surface is essentially parallel to the given plane of saw blade cutting travel.

7. The sawmill of claim 6, wherein:
the downslide comprises series of parallel ribs;
the series of parallel ribs that form the downslide are mounted to travel in left to right strokes relative each other but whereby not as in full left to right traverses of the traveling carriage for the bandsaw.

8. The sawmill of claim 7, wherein:
the series of parallel ribs that form the downslide extend from the upper rear transfer edges collectively thereof to the lower forward outflow edges collectively therefor such that the series of parallel ribs that form the downslide lie in the path of the blade of the bandsaw.

9. The sawmill of claim 8, wherein:
the series of parallel ribs that form the downslide are divided into a left-side series of parallel ribs always on the left of the blade of the bandsaw and right-side series of parallel ribs always on the right of the blade of the bandsaw.

10. The sawmill of claim 9, wherein:
the left-side series of parallel ribs are mounted and operable to telescopically expand and foreshorten as one collection between a fully-expanded apart extreme, in which the parallel ribs of the left-side series are relatively spaced apart from one another, and a fully-foreshortened extreme, in which the parallel ribs of the left-side series are relatively closer to or abutting one another; and
the right-side series of parallel ribs are comparably mounted and operable to telescopically expand and foreshorten as another collection between a fully-expanded apart extreme, in which the parallel ribs of the right-side series are relatively spaced apart from one another, and a fully-foreshortened extreme, in which the parallel ribs of the right-side series are shut or relatively shut with one another;
whereby the left-side series of parallel ribs and right-side series of parallel ribs can be operable to telescope expanded apart and foreshorten back to shut, or relatively shut, in opposition to one another and in correspondence with the traverse of the bandsaw back and forth such that the left-side series of parallel ribs and right-side series of parallel ribs avoid being sawn into by the blade of the bandsaw.

11. The sawmill of claim 10, wherein:
either the left-side series of parallel ribs or the right-side series of parallel ribs, or both, telescope between expanded apart and foreshortened shut, or relatively shut, extremes by virtue of a festooned cable system.

12. The sawmill of claim 1, wherein:
the log bunk comprises series of spaced parallel frames; and
wherein the backstop assembly comprises a corresponding series of head assemblies that translate over the series of spaced parallel frames that form the primary support bed of the log bunk between forward and rearward extremes and presenting a cooperative backstop surface extending up and out from the primary support bed of the log bunk formed by the series of spaced parallel frames.

13. The sawmill of claim 12, wherein:
the log bunk comprises series of pairs of spaced parallel frames;
wherein the backstop assembly comprises a corresponding series of head assemblies; and
wherein each head assembly translates over a respective one of the pair of the series of spaced parallel frames.

14. The sawmill of claim 12, wherein:
the series of spaced parallel frames that form the log bunch are independently equipped with a respective rocking drive-source drive-system that drives a respective frame between the clockwise and counterclockwise extremes.

15. The sawmill of claim 14, wherein:
the rocking-drive source drive-system comprises a series of independently operable hydraulic cylinder systems; and
further comprising an electronic control system responsive to operator controls and in consequence thereof controlling the independently operable hydraulic cylinder systems.

16. The sawmill of claim 14, wherein:
the rocking-drive source drive-system comprises a series of independently operable rack-and-pinion drive systems; and
further comprising an electronic control system responsive to operator controls and in consequence thereof controlling the independently operable rack-and-pinion drive systems.

17. The sawmill of claim 14, wherein:
the rocking-drive source drive-system comprises a series of independently operable mechanism drive systems; and
further comprising an electronic control system responsive to operator controls and in consequence thereof controlling the independently operable mechanism drive systems.

18. The sawmill of claim 14, wherein:
the rocking-drive source drive-system comprises a series of independently operable cable or chain-and-sprocket drive systems; and
further comprising an electronic control system responsive to operator controls and in consequence thereof controlling the independently operable chain-and-sprocket drive systems.

19. The sawmill of claim 18, further comprising:
forward and rearward prop fixtures anchored underneath the log bunk and on a common ground with the rocking axis, said forward and rearward props fixtures providing counter-clockwise and clockwise tilting/rocking limits on the log bunk and providing prop support to weight on the log bunk whereby the forward and rearward prop fixtures provide support to a log when proximate the front edge proximate where saw operations are executed and proximate the rear edge proximate where fresh-log-infeed operations are executed.

20. The sawmill of claim 19, wherein:
the common ground comprises a common support framework.
